(19) United States
(12) Patent Application Publication
(10) Pub. No.: US 2015/0145671 A1
(43) Pub. Date: May 28, 2015

(54) SMART CLOTHING SYSTEM

(71) Applicants: Roy Cohen, Tenafly, NJ (US); Monica Lucas, Tenafly, NJ (US); Matthew David Shoup, San Jose, CA (US)

(72) Inventors: Roy Cohen, Tenafly, NJ (US); Monica Lucas, Tenafly, NJ (US); Matthew David Shoup, San Jose, CA (US)

(21) Appl. No.: 14/551,771

(22) Filed: Nov. 24, 2014

Related U.S. Application Data
(60) Provisional application No. 61/907,490, filed on Nov. 22, 2013.

(51) Int. Cl. A41D 1/00; G08B 21/18

(52) U.S. Cl. CPC A41D 1/00; G08B 21/18
USPC 340/539.11

(57) ABSTRACT

Techniques pertaining to wearable technology are described. According to various embodiments, one or more sensors embedded in or attached to an article of clothing detect that the clothing is in physical contact with a user at a particular time. Thereafter, it is determined that the article of clothing is being worn by the user at the particular time, based on the detecting. Further, user wear history information may be generated, the user wear history indicating that, at the particular time, the user is wearing the article of clothing. The user wear history information may include one or more data points associated with one or more specified times, each of the data points indicating whether the article of clothing is being worn by the user or is not being worn by the user at the corresponding specified time.

### CLAIM OF PRIORITY

This application claims the priority benefit of U.S. Provisional Application No. 61/907,490, filed Nov. 22, 2013, which is incorporated herein by reference.

### TECHNICAL FIELD

The present application relates generally to data processing systems and, in one specific example, to wearable technology.

### BACKGROUND

Various conventional retail systems (e.g., point of sale systems, customer relationship management databases, etc.) may maintain purchase history information in order to keep track of clothing items being sold.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed;

FIG. 2 is a block diagram of an example system, according to various embodiments;

FIG. 3 is a block diagram of a smart clothing tag, according to various embodiments;

FIG. 4 illustrates an example method, according to various embodiments;

FIG. 5 illustrates an example method, according to various embodiments;

FIG. 6 is a flowchart illustrating an example method, according to various embodiments;

FIG. 7 illustrates an example method, according to various embodiments;

FIG. 8 is a block diagram of an example system, according to various embodiments;

FIG. 9 illustrates example wearing behavior information, according to various embodiments;

FIG. 10 is a flowchart illustrating an example method, according to various embodiments;

FIG. 11 is a flowchart illustrating an example method, according to various embodiments;

FIG. 12 is a flowchart illustrating an example method, according to various embodiments;

FIG. 13 is a flowchart illustrating an example method, according to various embodiments;

FIG. 14 is a flowchart illustrating an example method, according to various embodiments;

FIG. 15 is a flowchart illustrating an example method, according to various embodiments;

FIG. 16 illustrates an example mobile device, according to various embodiments; and

FIG. 17 is a diagrammatic representation of a machine in the example form of a computer system within which a set of instructions, for causing the machine to perform any one or more of the methodologies discussed herein, may be executed.

### DETAILED DESCRIPTION

Example methods and systems pertaining to wearable technology are described. In the following description, for purposes of explanation, numerous specific details are set forth in order to provide a thorough understanding of example embodiments. It will be evident, however, to one skilled in the art that the present invention may be practiced without these specific details.

According to various example embodiments, a smart clothing system includes an electronic tag or chip (referred to herein as a smart clothing tag) that may be embedded into or attached to various articles of clothing and other wearable attire, including shirts, pants, dresses, shoes, socks, hats, ties, scarves, handbags, t-shirts, blouses, sweaters, jackets, watches, wrist bands, head bands, sweat bands, and so on. In some embodiments, the smart clothing system may also include or be connected to a cloud storage system (e.g., one or more application servers or Web servers) that is configured to retrieve and analyze various data stored in a memory unit or storage unit included in the smart clothing tag, as described in more detail below. Accordingly, the smart clothing tag may correspond to an end user device that may be deployed in various articles of clothing, where each article of clothing may have its own smart clothing tag and thus may have intelligence associated with it. Various embodiments herein refer to a clothing lease program, where an article of clothing including a smart clothing tag is leased to the user. Alternatively, the user may purchase an article of clothing including the smart clothing tag. As described in more detail below, the smart clothing system is designed to be as subtle and as non-disruptive to the user's life as possible.

According to various example embodiments, each smart clothing tag may include a memory or storage unit that stores various data or information associated with the corresponding article of clothing, such as brand, model, size, color, style, material, pricing, promotional or “on sale” tags, reviews, product identification number (e.g., stock keeping unit (SKU), international standard book number (ISBN), manufacturer part number (MPN), global trade item number (GTIN)), purchase history information (e.g., time and location where the item was purchased), order information (e.g., links to product item listing page on a manufacturer's website or an online retailer), workmanship, quality of the materials, manufacturer's process for quality assurance, environmental impact, or any other attributes of the article of clothing. This storage unit may be an interconnected component with the rest of the hardware of the system, or may be separate from the rest of the hardware of the system. In some embodiments, the storage unit may be used only for identification purposes. Accordingly, in some embodiments, the smart clothing tag may be coded with a unique fingerprint identifying various uniquely identifiable attributes of the article of clothing. It is understood that the smart clothing tag may be coded with the aforementioned information (either in its entirety, or any portion thereof), or the smart clothing tag may be coded with links (e.g., a uniform resource identifier (URI) or uniform resource locator (URL)) for accessing any of the aforementioned information. According to various example embodiments, the information may be encoded into the smart clothing tag by, for example, a manufacturer or retailer of the corresponding article of clothing, or by the user.

According to various example embodiments, each smart clothing tag may be coded with end-user information describing the person wearing the clothing. An example of end-user information includes name, address, phone number, e-mail address, social media handle or username, (e.g., user name on Facebook, Twitter, LinkedIn, Google plus, etc.), a link to a web page associated with the user (e.g., a webpage on a social network service such as Facebook®, Twitter®, LinkedIn®, Google® plus, etc., or a link to a bio page, personal home page, web blog, etc.), a link to purchase history information associated with the user (e.g., brand, size, color, price, etc., of previous orders in the user's purchase history on Poshmark®, Threadflip®, Etsy®, Wanelo®, etc.), a link to data specifying interests, preferences, recommendations, etc., associated with the user, and so on. In some embodiments, the end-user information may be encoded into the memory of the smart clothing tag when the user purchases or otherwise obtains the article of clothing. For example, if the user purchases the article of clothing in a retail store, then a sales associate of the retail store may ask the user to provide various end-user information for encoding into the smart clothing tag. Alternatively, the user may provide the sales associated with a link (e.g., URL) to profile information of the user (e.g., a user profile on an online retailer, online marketplace, social media profile, etc.) where the corresponding end-user information may be accessed and encoded into the smart clothing tag. If the user purchases the article of clothing online, the smart clothing system may request the user to enter profile information (or provide a link for accessing such profile information), and then the smart clothing system may encode this profile information into the smart user tag. The user may also be able to associate further personally identifiable information onto a supporting phone application or website.

According to various example embodiments, a smart clothing system is configured to detect when a piece of clothing is being worn by a user. For example, in some example embodiments, the smart clothing tag may include a capacitive sensor configured to detect if someone is wearing the article of clothing. Capacitive touchscreens included in cell phones are already used within the cell phone industry in order to distinguish and sense specific touch against the capacitive touchscreen, as understood by those skilled in the art. Capacitive touch screens rely on the electrical properties and electrical impulses of the human body in order to detect when and where the user is touching their finger against the touchscreen display. More specifically, the touch of a fingerprint against the touchscreen creates an electrical distortion in the screen's capacitive field when impressed upon by body capacitance (the physical property of the human body that enables it to act as an electrical capacitor or conductor of electric charges). Accordingly, in various example embodiments described in more detail below, a capacitive sensor may be integrated into an article of clothing in order to detect when the article of clothing is being touched by the user in a particular manner. For example, the smart clothing tag may include a circuit board embedded into (or attached to) the piece of clothing that is configured to sense if a user is currently wearing the piece of clothing, based on capacitive sensing, or based on other sensors, as described in more detail below.

Another technique utilized by the smart clothing tag for detecting if the clothing is being worn may be through the use of RF (Radio Frequency) transceiver modules to detect bodies through passive sensing of changes in the magnitude of radio waves that would be caused by a person putting on the piece of clothing. This technique may be implemented through the use of two antennas embedded on either side of the printed circuit board of the smart clothing tag embedded in (or attached to) the clothing, with the second antenna being pointing at the human body. In some embodiments, only one of the two antennas would be transmitting from the RF radio transceiver at any one time through the use of an RF switch included in the RF radio transceiver. The transceiver may transmit and receive information using the first antenna registering a certain power level of the signal it is receiving, and then it may switch to using the second antenna which is mounted much closer to where a human body should be. If a human is in fact wearing the article of clothing, the second antenna mounted towards the body should register a lower power level due to the attenuation of the RF signals which would have to pass through the human in order to be received. Other techniques utilized by the smart clothing tag to detect that clothing is being worn may include measuring body temperature differentials created by the wearer putting on the clothing, or using the piezoelectric elements that are used for charging (as described in more detail elsewhere herein) to detect footsteps and other typical motions.

According to various example embodiments, the smart clothing system including the smart clothing tag is configured to detect when a first piece of clothing being worn by a user is covered (e.g., by a second piece of clothing that might obstruct the first piece from an observer's view). For example, the smart clothing tag may include an infrared (IR) reflectance sensor that may be used to detect if the person has covered the article of clothing (e.g., with another piece of clothing). More specifically, the IR reflectance sensor may supply its own light source within the infrared spectrum of light, and may detect whether any of the supplied light source is reflected back to the sensor. Accordingly, if the reflected light levels fall below a predetermined threshold, the smart clothing tag may determine that the article of clothing is covered (e.g., by another article of clothing). Because the IR reflectance sensor operates in the Infrared spectrum, the light it emits is invisible to the human eye and will not change people's views of the clothing. In some embodiments, the smart clothing tag may utilize an ambient light detection sensor in conjunction with or as a replacement to the aforementioned IR reflectance sensor to detect the ambient light levels proximate to the article of clothing (where the ambient light sensor may be separate from the aforementioned IR reflectance sensor or may be a component of the aforementioned IR reflectance sensor). Accordingly, if the ambient light levels fall below a predetermined threshold, the smart clothing tag may determine that the article of clothing is covered (e.g., by another article of clothing). During certain conditions (e.g., night time), ambient light level detection may not be an accurate way to detect whether the article of clothing is being covered. Accordingly, in some embodiments, the smart clothing tag may identify current atmospheric and lighting conditions (e.g., based on the time of day, sunset and sunrise at current location, etc.) in order to determine whether to utilize the ambient light detection sensor or the IR reflectance sensor to detect whether the article of clothing is covered or not.

According to various example embodiments, the smart clothing tag may include a power source (e.g., a battery, super capacitor, etc.) integrated within or connected to the smart clothing tag that is configured to power the operation of the various components of the smart clothing tag. In some embodiments, the smart clothing tag is configured to be self-charging, and the smart clothing tag may include a piezoelectric generator or some other type of parasitic power generation mechanism configured to charge a power source (e.g., a battery, super capacitor, etc.) integrated within the smart clothing tag. The piezoelectric generator may be a layer of crystals that are configured to produce power for the smart clothing tag in accordance with the piezoelectric effect. Such small mechanical stresses may be generated when the corresponding article of clothing that includes the smart clothing tag is moved in various ways (e.g., when the user wearing the article of clothing walks or moves their body, etc.). Moreover, in some embodiments, the piezoelectric generator is configured to recharge the battery of the smart clothing tag when the smart clothing tag and the article of clothing are placed into a washing or drying machine, based upon the application of mechanical stress, pressure and vibrations towards the article of clothing during the washing process. Thus, because the smart clothing tag may be self-charging, a wearer does not need to take any special action to charge the smart clothing tag or do anything out of the ordinary. In other embodiments, a smart clothing tag may be charged based on wireless charging by placing the item of clothing including the smart clothing tag on a wireless charging surface, which may be incorporated into a specialized coat hanger, coat hook, or a wireless charging mat integrated into a cover for a bed, a chair, a clothing rack, an ironing board, and so on. To reduce circuit board surface area, conductive fibers may be sewn into the fabric that may be used for wireless power reception. Another possible power generation method may include sewing flexible solar cells underneath the clothing such that they are almost constantly passively charging the batteries of the device. Advancements in materials may also enable sections of the fabric itself to undergo coatings that would allow them to generate electricity in the same way as the aforementioned solar cells.

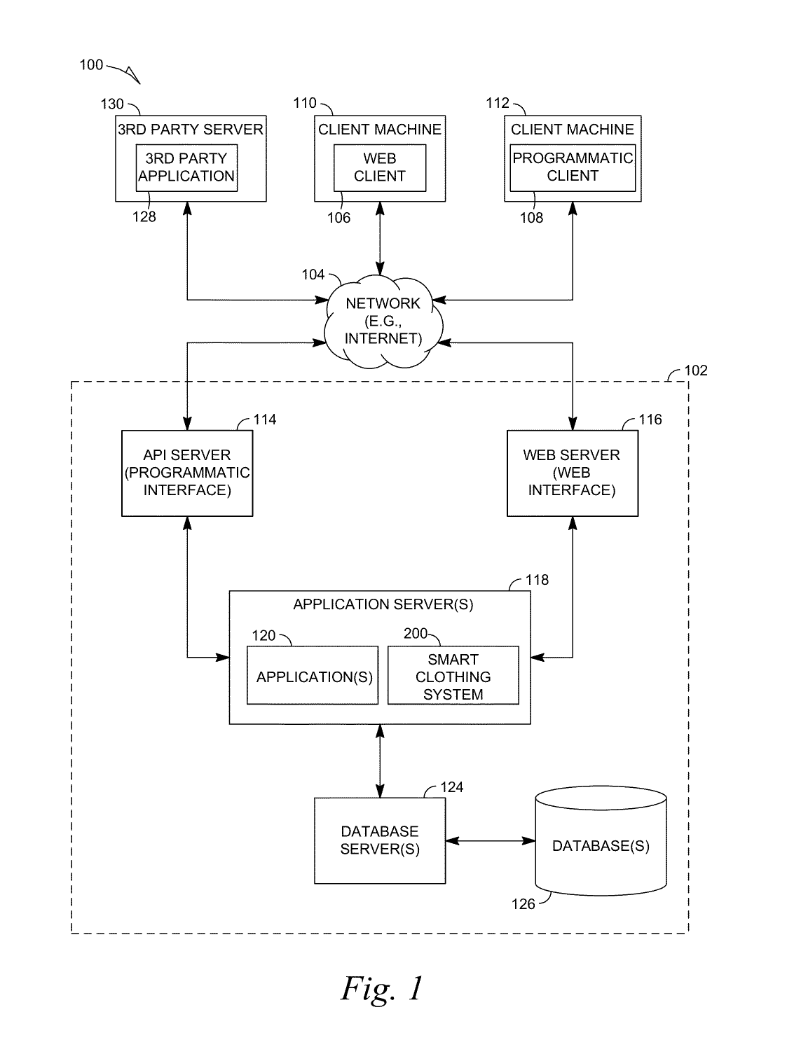

FIG. 1 is a network diagram depicting a client-server system 100, within which one example embodiment may be deployed. A networked system 102 provides server-side functionality via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

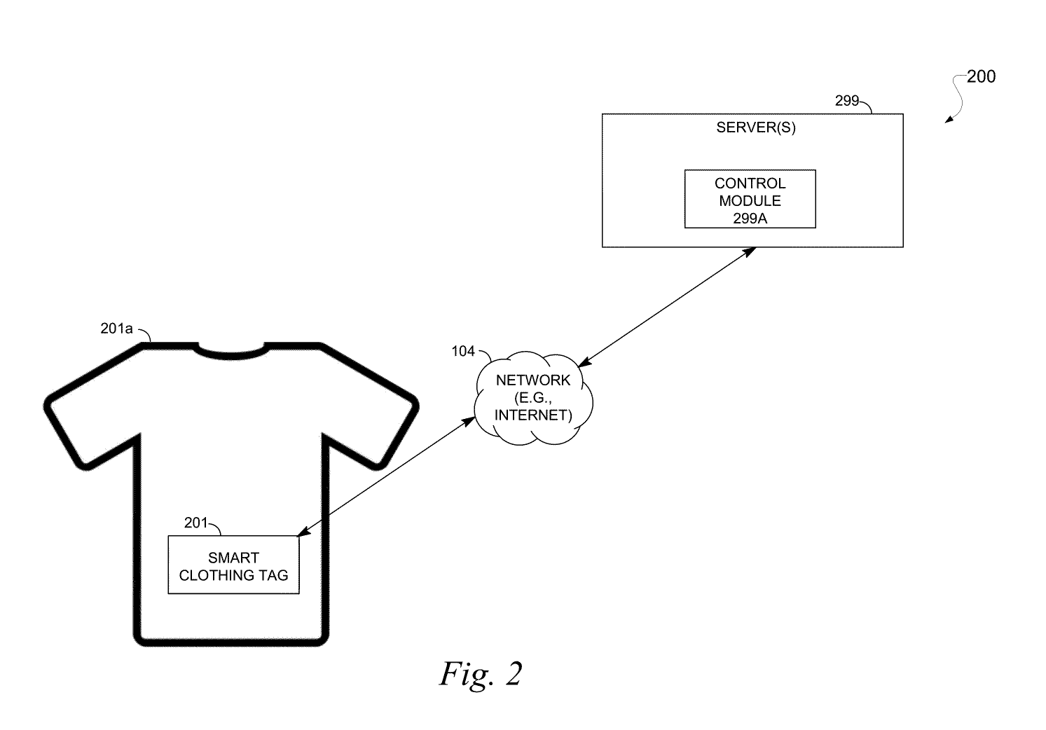

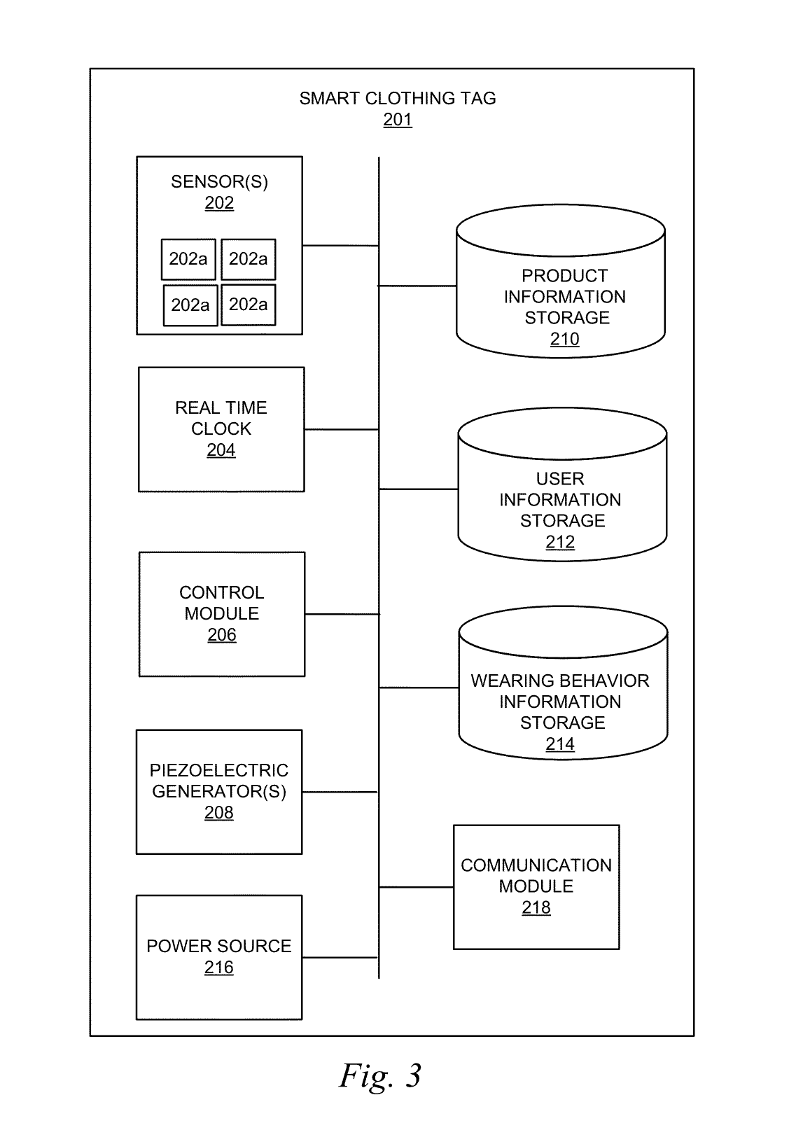

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more databases servers 124 that facilitate access to one or more databases 126. According to various example embodiments, the applications 120 may be implemented on or executed by one or more of the modules of the smart clothing system 200 illustrated in FIG. 2 and FIG. 3. While the applications 120 are shown in FIG. 1 to form part of the networked system 102, it will be appreciated that, in alternative embodiments, the applications 120 may form part of a service that is separate and distinct from the networked system 102. With some embodiments, the application servers 118 hosts what is referred to herein as a smart clothing system 200. The smart clothing system 200 is described in more detail below in conjunction with FIG. 2 and FIG. 3.

Further, while the smart clothing system 200 shown in FIG. 1 employs a client-server architecture, the present invention is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

### Hardware Overview

Turning now to FIG. 2, a smart clothing system 200 includes a smart clothing tag 201 embedded into (or attached to) an article of clothing 201a and a server 299 (or servers 299). The smart clothing tag 201 may communicate with the server 299 via a network 104 (e.g., the Internet). In some embodiments, the server 299 may include a control module 299A. As illustrated in FIG. 3, the smart clothing tag 201 embedded into an article of clothing 201a includes one or more sensors 202, a real-time clock 204, a control module 206, a piezoelectric generator 208, a product information storage database 210 configured to store product information, a user information storage database 212 configured to store user information, a wearing behavior information storage database 214 configured to store wearing behavior information (also referred to herein as user wear history information), a power source 216 (e.g., a battery), and a communication module 218 (e.g., a wireless communication module, Bluetooth communication module, a near field communication (NFC) module, etc.). The modules of the smart clothing tag 201 may be implemented on or executed by a single device such as a smart clothing device, or on separate devices interconnected via a network. The aforementioned smart clothing device may be, for example, one of the client machines (e.g. 110, 112) or application server(s) 118 illustrated in FIG. 1. The smart clothing tag 201 may be configured to communicate with a server of the smart clothing system 200 (see FIG. 1).

Each of the hardware components 202-218 of the smart clothing tag 201 in FIG. 2 may be embedded into (or attached to) the article of clothing 201a, either separately or in combination, and may be configured to log various sensor data until such data can be relayed to servers of the smart clothing system 200 (e.g., see server 299 in FIG. 2). For example, the hardware components 202-218 of the smart clothing tag 201 in FIG. 2 may be sewn or bonded to the article of clothing 201a. As another example, the hardware components 202-218 of the smart clothing tag 201 in FIG. 2 may be clipped to the article of clothing 201a with one or more clipping devices.

According to various example embodiments, the sensors 202 may include a capacitive sensing chip or capacitive sensor 202a configured to detect if someone is in fact wearing the article of clothing. Because capacitive sensing relies on larger surface areas to be used for proximity detection (e.g., detection of near contact but not detection of touching), a ground layer of a circuit board of the smart clothing tag 201 may be used as the capacitive panel. Alternatively, the smart clothing tag 201 may be comprised of a multilayer circuit board with an entire layer devoted to the capacitive surface. In other embodiments, if a specific article of clothing does not have the room for a circuit board with a capacitive pad built into it, a piece of conductive fabric may be sewn into the article of clothing making the circuit board size of the smart clothing tag 201 even smaller. Capacitive sensing enables the smart clothing tag 201 to reject false positives that could be present in its environment as well as to prevent people from trying to mislead the control module 206 into determining that the article is/is not being worn. As described above, the control module 206 may remain in a low-power sleep mode. Accordingly, order to conserve battery power, the capacitive sensor 202a may include a special output called an interrupt, enabling the capacitive sensor 202a to detect when a user physically touches it, and only then sending an interrupt signal to the control module 206 of the smart clothing tag 201, via the interrupt output, to instruct the control module 206 to exit sleep mode. Consistent with various embodiments described throughout, the sensors 202 may also include an IR reflectance sensor 202b, an ambient light sensor 202c, and an accelerometer 202d.

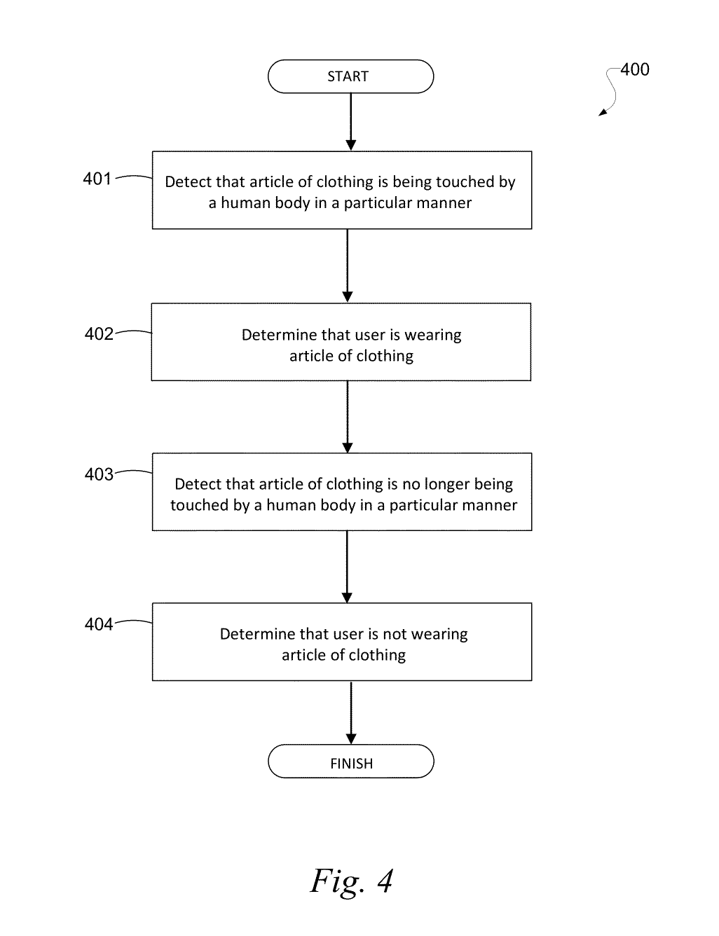

FIG. 4 is a flowchart illustrating an example method 400, consistent with various embodiments described above. The method 400 may be performed at least in part by, for example, the smart clothing tag 201 illustrated in FIG. 2 (or an apparatus having similar modules, such as client machines 110 and 112 or application server 118 illustrated in FIG. 1). In operation 401, one or more sensors (e.g., the capacitive sensor 202) embedded in or attached to an article of clothing detects that the clothing is being touched by a human body in a particular manner (e.g., the capacitive sensor 202 may detect contact for at least a predetermined time interval, such as 1 second). The capacitive sensor 202 may output a signal to the control module 206 to indicate the detection of this event. In operation 402, the control module 206 determines that the article of clothing is currently being worn by a person, based on the detection event in operation 401. The control module 206 may also modify user wear history information to indicate that the person is wearing the article of clothing. In operation 403, one or more sensors (e.g., the capacitive sensor 202) embedded in or attached to the article of clothing detects that the clothing is no longer being touched by a human body in a particular manner. The capacitive sensor 202 may output a signal to the control module 206 to indicate the detection of this event. In operation 404, the control module 206 determines that the article of clothing is currently not being worn by the person, based on the detection event in operation 403. The control module 206 may also modify the user wear history information to indicate that the person is not wearing the article of clothing.

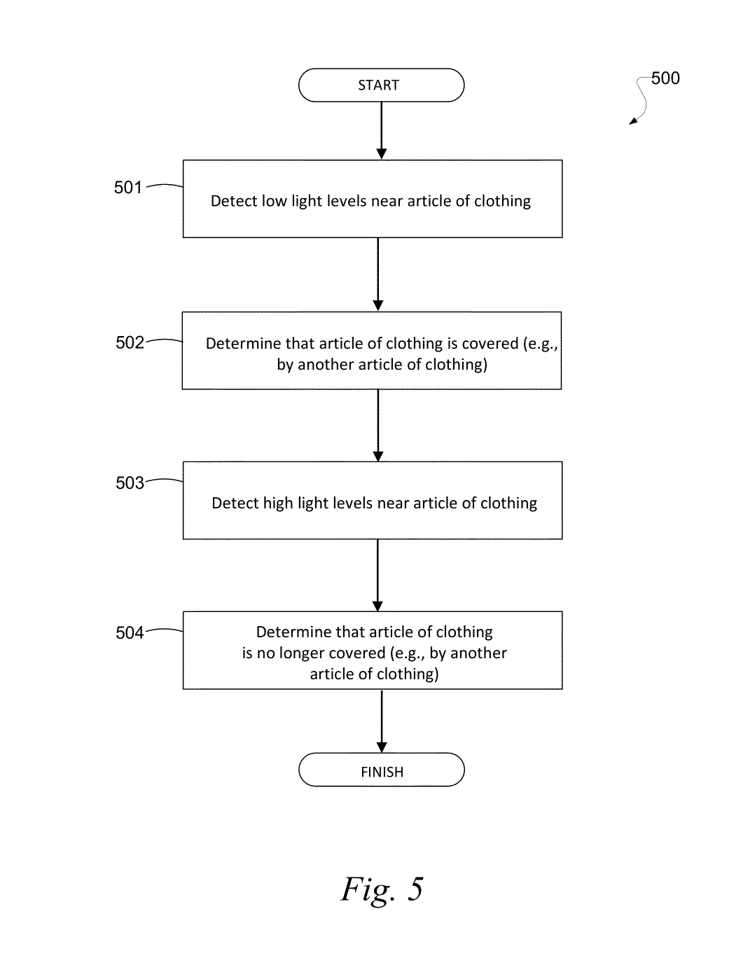

FIG. 5 is a flowchart illustrating an example method 500, consistent with various embodiments described above. The method 500 may be performed at least in part by, for example, the smart clothing tag 201 illustrated in FIG. 2 (or an apparatus having similar modules, such as client machines 110 and 112 or application server 118 illustrated in FIG. 1). In some embodiments, the operation 500 may occur, for example, after the operation 402 and before the operation 403 in the method 400 in FIG. 4. In operation 501, one or more sensors (e.g., the IR reflectance sensor 202b and/or ambient light detection sensor 202c) embedded in or attached to an article of clothing detects that the amount of reflected light or ambient light reaching the article of clothing falls below a predetermined threshold (or falls by a predetermined threshold or percentage). For example, the IR reflectance sensor 202b may emit an IR light, detect the amount of reflected light emanating from the IR light, and compare the amount of reflected light to the predetermined threshold. The IR reflectance sensor 202b and/or ambient light detection sensor 202c may output a signal to the control module 206 to indicate the detection of this event.

In operation 502, the control module 206 determines that the article of clothing is currently covered (e.g., by another article of clothing), based on the detection event in operation 501. In operation 503, one or more sensors (e.g., the IR reflectance sensor 202b and/or ambient light detection sensor 202c) embedded in or attached to the article of clothing detects that the amount of reflected light or ambient light reaching the article of clothing is greater than a predetermined threshold (or increases by a predetermined threshold or percentage). For example, the IR reflectance sensor 202b may emit an IR light, detect the amount of reflected light emanating from the IR light, and compare the amount of reflected light to the predetermined threshold. The IR reflectance sensor and/or ambient light detection sensor 202 may output a signal to the control module 206 to indicate the detection of this event. In operation 504, the control module 206 determines that the article of clothing is no longer covered (e.g., by another article of clothing), based on the detection event in operation 503.

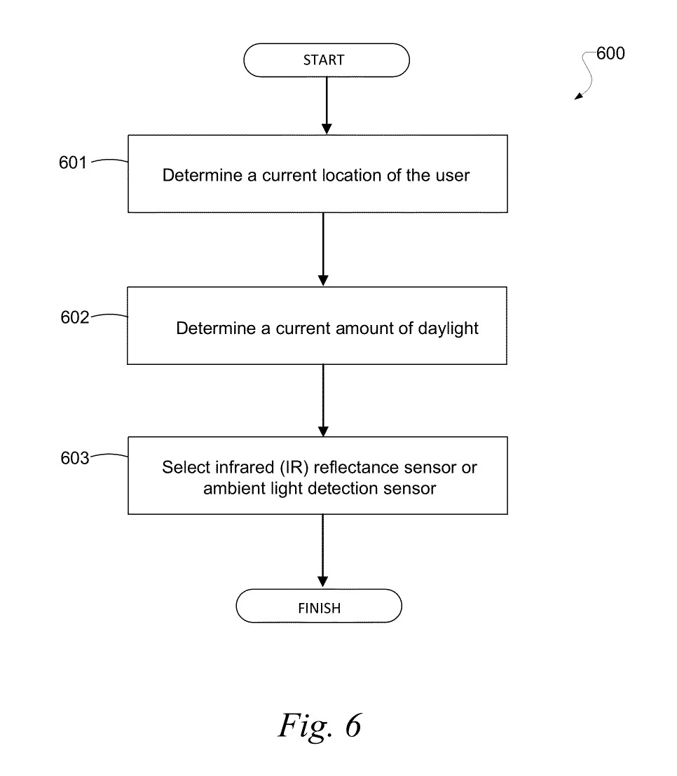

FIG. 6 is a flowchart illustrating an example method 600, consistent with various embodiments described above. The method 600 may be performed at least in part by, for example, the smart clothing system 200 illustrated in FIG. 2 (or an apparatus having similar modules, such as one or more client machines or application servers). In operation 601, the control module 206 determines a current location of the user (e.g., based on geolocation information received from a smart phone of the user). In operation 602, the control module 206 determines a current amount of daylight at the current location of the user, based upon weather information (e.g., weather reports accessible via the Internet that indicate current light levels, current time, sunrise, sunset etc.). In operation 603, the control module 206 selects any one of the infrared (IR) reflectance sensor 202b and the ambient light detection sensor 202c for detecting the amount of reflected light or ambient light reaching the article of clothing (see operation 401 and 403 in FIG. 4), based on the determined current amount of daylight. For example, if the amount of daylight is low, the control module 206 may select IR reflectance sensor 202b and not the ambient light detection sensor 202c. It is contemplated that the operations of method 600 may incorporate any of the other features disclosed herein. Various operations in the method 600 may be omitted or rearranged, as necessary. The method 600 enables the smart clothing tag 201 to save power and extend battery life by reducing the use of the IR reflectance sensor 202b, as it generally consumes more current to emit and detect IR light than utilizing conventional passively sensing ambient light sensors (such as ambient light sensor 202c) to detect daylight. Accordingly, during daylight, the smart clothing tag 201 does not need to utilize the IR reflectance sensor 202b to emit or detect IR light, and may rely solely on the ambient light sensor 202c to detect ambient light levels (e.g., daylight) proximate to the article of clothing.

Referring back to FIG. 2, the Real-time clock (RTC) 204 may be any conventional real-time clock as understood by those skilled in the art. In some embodiments, the RTC 204 may be replaced with a small low power processor that may exit sleep mode at a particular cadence or periodic time interval to activate or “wake up” the smart clothing tag 201. Conventional RTCs are generally designed for accurate timekeeping with minimal error or “drift”, and since the smart clothing tag 201 may communicate with servers 299 frequently, any drift caused by inconsistencies may be calibrated out when syncing with the timekeeping systems of the servers 299. Furthermore, the control module 206 used for controlling the smart clothing tag 201 may be configured for a low-power “sleep mode”, and the RTC 204 may serve as a low-power source for counting clock cycles, such that the control module 206 may save power consumption by the remaining in a sleep state until the lower power counting device (e.g., RTC 204 or equivalent) to activates or wakes it from sleep mode.

In some embodiments, the real time clock(s) 204 are configured to generate a timestamp associated with each data point collected by each of the sensors 202. For example, the real time clock(s) 204 may be used to keep accurate time even when the smart clothing system 200 is not in communication with a bridge device such as a user's smartphone. This is advantageous because although a microprocessor (e.g., control module 206) of the smart clothing tag 201 may have clocks built into it to allow it to function by providing pulses of electricity in accordance with a clock signal, they may not be accurate at keeping time. Thus, even if the control module 206 is unable to upload information to the server 299 in real time (e.g., due to connection problems), the control module 206 may save information in memory (e.g., for a predetermined amount of time) in association with time stamp data, in order to conserve battery life. A timestamp and a possible geotag may be associated with each datapoint the sensors 202 collect in order to know exactly what was happening (e.g., user is wearing clothing or not, clothing is covered or not) at a given time.

Consistent with various embodiments described above, the smart clothing tag 201 may include piezoelectric generators 208 that may be used as a power generation source for the hardware. The piezoelectric generators 208 use the Piezoelectric effect to generate very small amounts of power every time they are mechanically stressed (e.g., bent, stretched, twisted, etc.). The control module 206 of the smart clothing tag 201 may function on a single battery charge for as long as possible (e.g., the duration of a clothing lease with the user) but because of certain power intensive features of the smart clothing tag 201 (such as radio communication by the communication module 218), it might be advantageous to supplement the battery power with other sources. Accordingly, the Piezoelectric generators 208 may be placed in the clothing such that when the user wearing the clothing moves or the clothing is placed in the washing machine, the continuous mechanical stress of being moved or being washed may produce power to charge the battery which may increase times between conventional battery charges. As understood by those skilled in the art, such 208 have been shown producing energy just by touching a vibrating surface. Thus, just placing the clothing including the piezoelectric generator 208 on top of a washing machine or even inside a moving vehicle may also produce energy. In some embodiments, Wireless charging may enable the smart clothing tag 201 to be charged by placing the underlying article of clothing 201a on a special cloth hanger. This hanger may have a coil built into it and may charge the battery 216 of the smart clothing tag 201 in an efficient and expeditious manner. For example, a special hangar may be sent to the user with the piece of clothing. This technique is not exclusive to hangars, and it could be embedded into a range of household items that would allow for subtle charging of the device without interfering with the user's normal schedule. Charging mats may also be sown into bed covers or chair covers, such that placing the piece of clothing there (e.g., at night or when selecting the clothes out of their closet) may charge the battery 216 to prolong the battery life. In some embodiments, the smart clothing tag 201 may only upload information to the servers 299 when the clothing is put on the special coat rack that energizes the smart clothing tag 201 and triggers the transfer of the information (e.g., at night). In this embodiment, the smart clothing tag 201 may only use its onboard battery 216 for collecting and storing sensor 202 data, rather than radio communication.

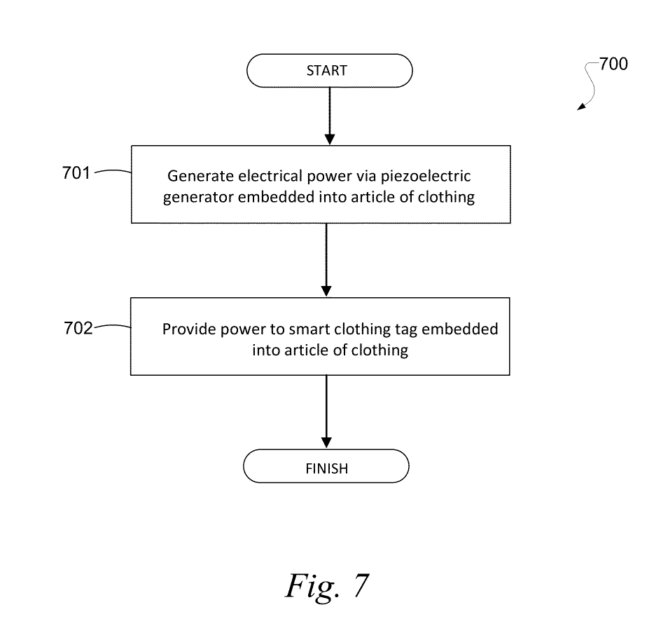

FIG. 7 is a flowchart illustrating an example method 700, consistent with various embodiments described above. The method 700 may be performed at least in part by, for example, the smart clothing tag 201 illustrated in FIG. 2 (or an apparatus having similar modules, such as client machines 110 and 112 or application server 118 illustrated in FIG. 1). In operation 701, the piezoelectric generator 208 embedded into (or attached to) an article of clothing generates electrical power based on mechanical stress, pressure, or vibration applied to the article of clothing. In operation 702, the piezoelectric generator 208 supplies electrical power to various components of a smart clothing tag 201 embedded into (or attached to) the article of clothing (e.g., the module 202-218 in the smart clothing tag 201 in FIG. 2).

The various hardware 202-218 may sustain itself by conserving power (e.g., as described above) so that one charge cycle may extend for as long as possible (e.g., possibly a whole span of a clothing lease) or it may be charged in ways that are passive or non-disruptive to the users lifestyle (e.g., as described above). Due to power limitations, a bridge technology may be used to relay information to servers 299 of the smart clothing system 200. As described in more detail below, the bridge technology may be a user's smartphone, although other technologies (e.g., smart watchers, vehicle computing systems, etc.) can be used to supplement or replace the smart phone. This allows the smart clothing system 200 to attach additional information to the data collected by the smart clothing tags 201 using location services (e.g., GPS) and other data gathering technologies already implemented in all modern smartphones. Surplus non critical data may be generated as a by-product of the specific sensing technologies (e.g., the sensors 202) implemented in the smart clothing tag 201. This surplus data may be stored in memory of the smart clothing tag 201 in association with a lower priority, and only relayed to the server 299 and/or retained in the memory of the smart clothing tag 201 if system resources (e.g., memory space) are available.

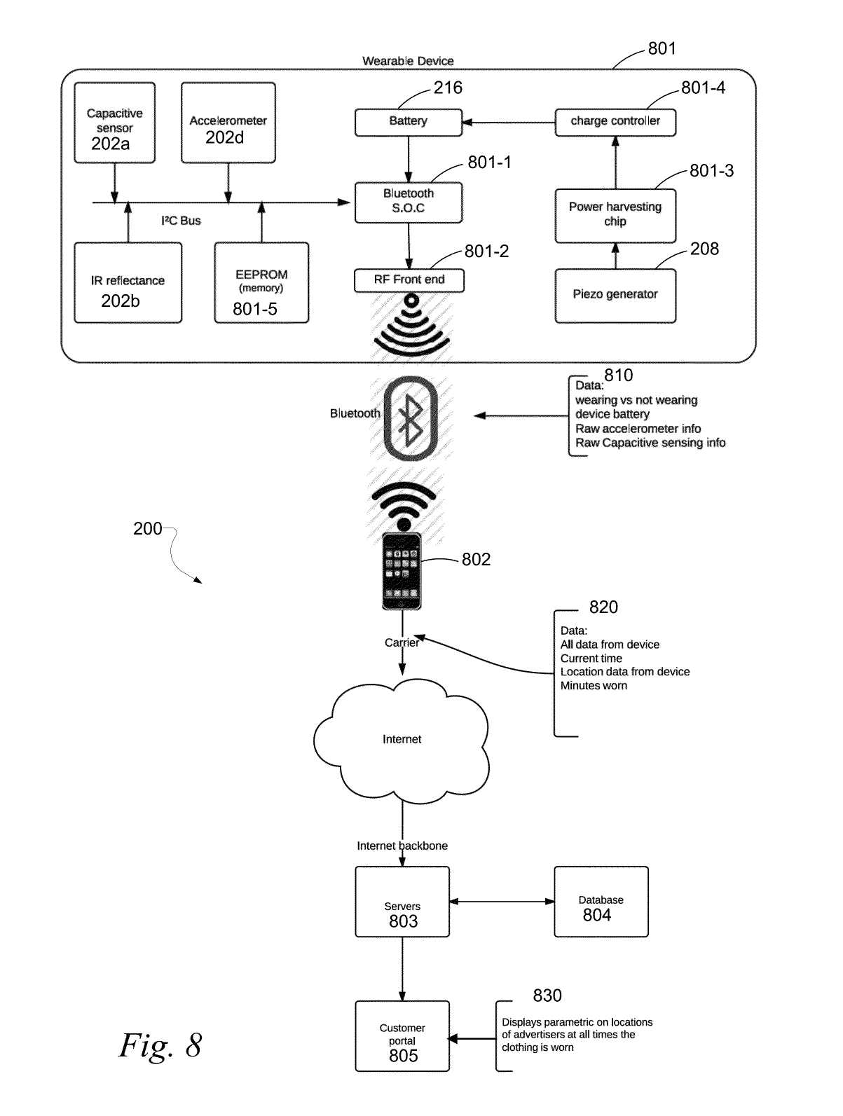

According to various example embodiments, a bridge technology may be a user's cell phone (e.g., over Bluetooth), a home base station, a retailer's front door, store shelves, security system, or an NFC station. For example, FIG. 8 illustrates an alternative depiction of the smart clothing system 200 illustrated in FIG. 2. A wearable device 801 (which may correspond to the smart clothing tag 201) communications with a user's cell phone 802, which in turn communicates with servers 803 (which is connected to database 804 and customer portal 805 that displays information 830). The wearable device 801 includes a Bluetooth system-on-chip (S.O.C.) 801-1, RF front end 801-2, which may together correspond to the communication module 218 in FIG. 2. Further, the wearable device 801 includes a power harvesting chip 801-3 and charge controller 801-4 configured to convert the power from piezo generator 208 into power for the battery 216. Further, the wearable device 801 includes a memory 801-5 that may correspond to the product information storage database 210, the user information storage database 212, and the wear history information storage database 214 illustrated in FIG. 2. As illustrated in FIG. 8, the user's cell phone 802 may be used as a bridge between the wearable device 801 and the servers 803 on the internet. The wearable device 801 may activate its Bluetooth transmitter 801-1 periodically to connect to the phone 802 or server 803 and transfer the data 810 into a cloud system associated with the server 803. Prior to the data 810 being relayed over to the servers 803 using the phone's 802 internet connection, additional information could be added such as location data gathered by the GPS module or other location services of the 802. This information may allow clothing advertisers to see where leased clothing including the wearable device 801 has been worn and thus, where their brand is getting the most coverage. Thus, this information, together with current time information and information describing how long the wearable device has been worn, may be included to generate data 820 for upload to servers 803. In some embodiments, home base stations (not shown) similar to the servers 803 may be sent over to the user's home and linked to their internet connections. These base stations may act as internet gateways for a low power radio chipset embedded into the wearable device 801. This method could reduce power consumption of the wearable device 801 since it would only have to be activated periodically (e.g., once a day). In some embodiments, a Near Field Communication (NFC) antenna may be embedded into the wearable device 801 to enable it to upload information when the wearable device 801 is in close proximity to an NFC internet gateway (e.g., that may be embedded into the user's bedroom, closet, clothes rack, clothing bin, etc.).

In order to further increase the battery life of the device, a form of dynamic power rationing may be implemented in software associated with the smart clothing system. For example, a power rationing module may make power rationing decisions by prioritizing the lifespan of the battery over the timeliness, quality, or resolution of sensor measurements. The power rationing module may monitor and track the energy cost of every sensor and function, and monitor power usage levels. By knowing the estimated time of the devices deployment and the starting energy the device has in its battery, the power rationing module may be able to put limitations on how much energy the device is allowed to consume each day. For example, these limitations may apply to the number of times the device comes out of sleep mode to sense if the device's current state in the environment or what sensors the device will use at certain times or even how often the device attempts to communicate with a cloud based data collection mechanism or cloud or web based servers. These limitations may be implemented in order to best make use of the device's daily energy ration. Through active power usage measurements, the device may also be able to have proper feedback on how much power each of its activities are using rather than using “dead reckoning”, meaning if one day the device performed less efficiently than usual (due to external factors) and the device is nearing its daily limit, the device may change the amount of data samples it will take (e.g., for detecting whether a user is wearing an article of clothing or whether that article of clothing is covered) for only that day. Although sensor resolution and therefore data integrity may be diminished through this rationing, it may ensure increased longevity of the device's functioning state.

### Example Use Cases

According to various example embodiments, the smart clothing system 200 may compensate a user for advertising an item of clothing, based on determining that the user is wearing the item of clothing. Thus, the smart clothing system 200 incentivizes the user to effectively serve as a “walking billboard” for the article of clothing. For example, as described in more detail below, the smart clothing system 200 is configured to identify when (and for how long and how often) the user has worn an article of clothing. Thereafter, the smart clothing system 200 is configured to calculate an amount of compensation to be provided to the user, based on when and for how long the user has worn the clothing. Thus, the smart clothing system 200 rewards the user for wearing the clothing, and incentivizes them to continue to wear the clothing.

In some embodiments, the article of clothing may have been purchased by the user, where the user agreed to be compensated for serving as an advertisers or a “walking billboard” for the clothing. For example, the user may receive a discount or promotion on the purchase of articles of clothing including the smart clothing tag 201, or the user may receive a discount or promotion for future products, or the user may be paid at a specific rate (e.g., $1 per hour the clothing is worn), and so on. This approach may be advantageous because the manufacturer or retailer receiving the benefits of the advertising is not responsible for purchasing the products that are being advertised. In other embodiments, the article of clothing may be loaned to the user (or perhaps given or gifted fully to the user) by the manufacturer or retailer for free as “sponsored clothing” in a “pay to wear” model, where the clothing could be loaned to the user to wear for a specific amount of time and then returned, after which a new article could be sent to the participant to wear, enabling the relationship to be beneficial to both parties involved. In this way, the user may be able to refresh their wardrobe, and the manufacturers or retailers may get more of their clothing out in view of the public. The user could be further rewarded for interacting with the smart clothing system 200 and/or contributing more data to the smart clothing system 200 (e.g., by specifying location data, what other clothes they wore, style preferences, etc., into a webpage associated with the smart clothing system 200).

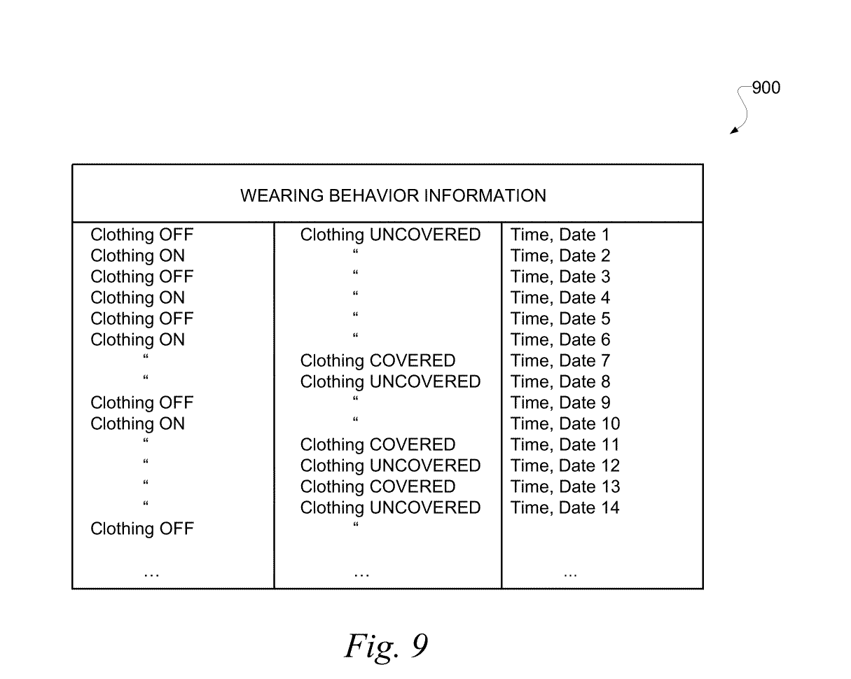

In some embodiments, the smart clothing system 200 may simply determine the compensation based on the total amount of time that the user has worn the particular article of clothing. For example, the smart clothing system 200 may be configured to compensate the user by paying a certain amount for each time interval (e.g., each hour) that the article of clothing is worn. (This amount may be applied in whole or in part as a refund for the article of clothing being worn by the user instead or in addition to paying them directly). For example, as described above, the smart clothing system 200 may include a capacitive sensor 202a that may determine when the user has put on and taken off an article of clothing. When the capacitive sensor 202a notifies the control module 206 of the smart clothing tag 201 that the user has put on the article of clothing or that the user has taken off the article of clothing, the control module 206 records the time in a storage unit 214 of the smart clothing tag 201. Thus, according to various example embodiments, each smart clothing tag 201 may be coded with wearing behavior information describing when the user put on the article of clothing and when the user took off the article of clothing (e.g., see FIG. 9). Such wearing behavior information may be stored in the memory 214 in the smart clothing tag 201 for later retrieval (e.g., by one or more application servers or Web servers 299). Based on this information, the smart clothing tag 201 may calculate the total amount of time that the user has worn the particular article of clothing, and can calculate the amount of compensation accordingly. In some embodiments, the smart clothing tag 201 may store this information, which may be later utilized in various ways (with or without compensation to the user).

In some embodiments, the rate applied for paying the user may vary based on when the user is wearing the article of clothing (e.g., a higher rate during weekday work hours or on Friday and Saturday evenings, a lower rate during sleeping hours, a higher rate during summer months, a lower rate during winter months, etc.), in order to reflect when the user is most likely to interact with other people or when the user is in close proximity with other smart clothing system 200 wearers. In some embodiments, higher rates can change over time as more information is collected on user behavior and a user's environment. In some embodiments, the user may be compensated with a fixed payment for wearing the article of clothing for a predetermined minimum period of time (e.g., $X for at least four hours in total over a week, or at least one hour a day for a week, at least one hour on Friday night, etc.).

According to various example embodiments described above, the smart clothing system 200 may determine if an article of clothing worn by the user is not available for advertising to others because it is covered (e.g., by another piece of clothing), or because that the user is laying down (which would imply his article of clothing isn't being exposed to others or that the user is sleeping). Moreover, through the use of either an accelerometer 202d or piezo element 208, the smart clothing system 200 may detect the orientation of the user. This gives the system 200 much more context about the information it is collecting which in turn increases the system's 200 confidence in the data, making the information that much more useful. For example, suppose the user is laying down in such a way that the light sensors 202b and 202c are not covered, (which would mean that the light sensors 202b and 202c would still be positively registering the user as wearing the clothing uncovered). This could mean that the user is actually sleeping (which would imply few impressions of the clothing by others). On the other hand, the user could be lying at the beach or the pool (which the control module 299a may determine by comparing geolocation information from the user's phone against the locations of known landmarks such as beaches and pools). Accordingly, the accelerometer 202d or piezo element 208 can be used as a secondary checking mechanism to determine the user's orientation and/or activity level and assess the amount of impressions or compensation they should receive.

Accordingly, the smart clothing system 200 may determine the compensation based on how long the user has worn the clothing in an uncovered state (e.g., when the article of clothing is not obstructed or covered by another article of clothing). For example, as described above, the smart clothing tag 201 may include a sensor (e.g., an IR reflectance sensor 202b or an ambient light sensor 202c) configured to determine when the user has covered or uncovered the article of clothing. Thus, when the capacitive sensor 202a determines that the user is wearing the article of clothing, and when the IR reflectance sensor 202b and/or ambient light sensor 202c notifies the control module 206 that the user has covered the article of clothing (or when the sensors 202b or 202c determine that the user is no longer covering the article of clothing), the control module 206 records this time in a storage unit 214 of the smart clothing tag 201. Thus, each smart clothing tag 201 may be coded with wearing behavior information describing when the user put on the article of clothing, when the user took off the article of clothing, when the user covered the article of clothing, and when the users uncovered the article of clothing (e.g., see FIG. 9). Such wearing behavior information may be stored in the memory 214 in the smart clothing tag 201 for later retrieval (e.g., by one or more application servers or Web servers 299). Based on this information, the smart clothing tag 201 may calculate the total amount of time that the user has worn the particular article of clothing in an uncovered state, and can calculate the amount of compensation accordingly. In other words, if the smart clothing system 200 determines that the user is wearing the article of clothing but the article of clothing is covered during a certain time interval, the smart clothing system 200 may reduce the amount of compensation paid to the user, based on the fact that the article of clothing was not displayed or advertised during that time interval.

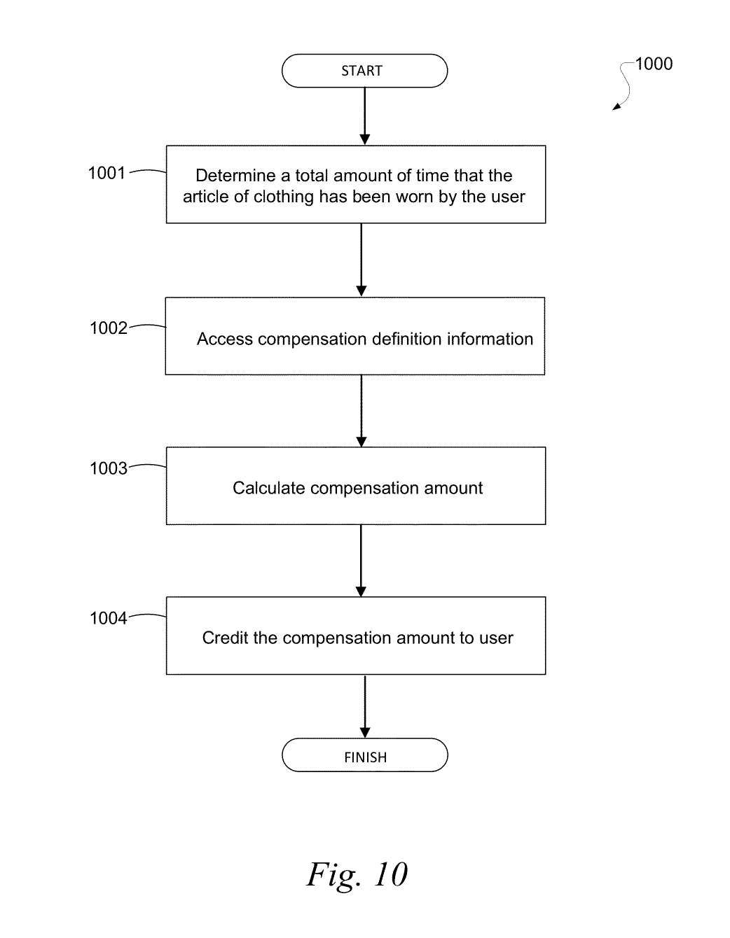

FIG. 10 is a flowchart illustrating an example method 1000, consistent with various embodiments described above. The method 1000 may be performed at least in part by, for example, the smart clothing system 200 illustrated in FIG. 2 (or an apparatus having similar modules, such as one or more client machines or application servers). In operation 1001, the server control module 299a determines, based on the user wear history information, a total amount of time that the article of clothing has been worn by the user. For example, the server control module 299a may identify, in the user wear history information, all data points indicating that the user is wearing the article of clothing, and the server control module 299a may calculate a total duration associated with these data points. Alternatively, in operation 1001, the server control module 299a may determine, based on the user wear history information, a total amount of time that the article of clothing has been worn by the user in an uncovered state. For example, the server control module 299a may identify, in the user wear history information, all data points indicating that the user is wearing the article of clothing and indicating that the article of clothing is not covered, and the server control module 299a may calculate a total duration associated with these data points. In operation 1002, the server control module 299a accesses compensation definition information defining a rate of compensation based on a total wearing time. In operation 1003, the server control module 299a calculates a compensation amount, based on the rate and the determined total amount of time that the article of clothing has been worn by the user (either in total or only in an uncovered state). In operation 1004, the server control module 299a credits the compensation amount to an online financial account associated with the user. It is contemplated that the operations of method 1000 may incorporate any of the other features disclosed herein. Various operations in the method 1000 may be omitted or rearranged, as necessary.

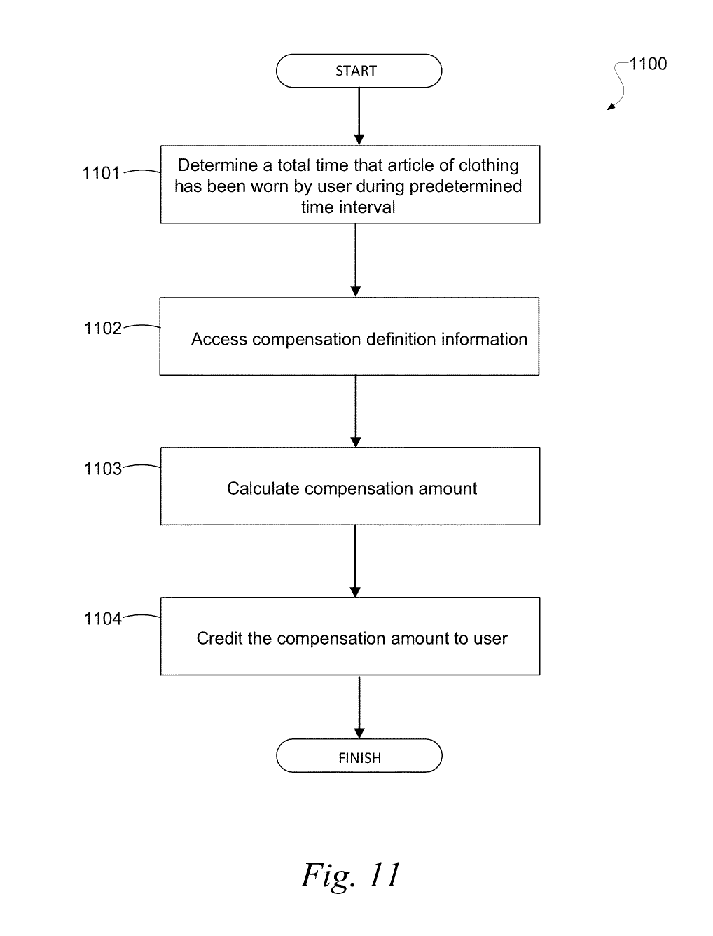

FIG. 11 is a flowchart illustrating an example method 1100, consistent with various embodiments described above. The method 1100 may be performed at least in part by, for example, the smart clothing system 200 illustrated in FIG. 2 (or an apparatus having similar modules, such as one or more client machines or application servers). In operation 1101, the server control module 299a determines, based on the user wear history information, a total amount of time that the article of clothing has been worn by the user during a predetermined time interval (e.g., a particular day of week, a particular time of day, or a particular season of year, etc.). For example, the server control module 299a may identify, in the user wear history information, all data points during the predetermined time interval indicating that the user is wearing the article of clothing, and the server control module 299a may calculate a total duration associated with these data points. Alternatively, in operation 1101, the server control module 299a determines, based on the user wear history information, a total amount of time that the article of clothing has been worn by the user in an uncovered state during a predetermined time interval (e.g., a particular day of week, a particular time of day, or a particular season of year, etc.). For example, the server control module 299a may identify, in the user wear history information, all data points during the predetermined time interval indicating that the user is wearing the article of clothing and indicating that the article of clothing is not covered, and the server control module 299a may calculate a total duration associated with these data points. In operation 1102, the server control module 299a accesses compensation definition information defining a rate of compensation based on a total wearing time during the predetermined time interval. In operation 1103, the server control module 299a calculates a compensation amount, based on the rate and the determined total amount of time that the article of clothing has been worn by the user (either in total or only in an uncovered state) during the predetermined time interval. In operation 1104, the server control module 299a credits the compensation amount to an online financial account associated with the user. It is contemplated that the operations of method 1100 may incorporate any of the other features disclosed herein. Various operations in the method 1100 may be omitted or rearranged, as necessary.

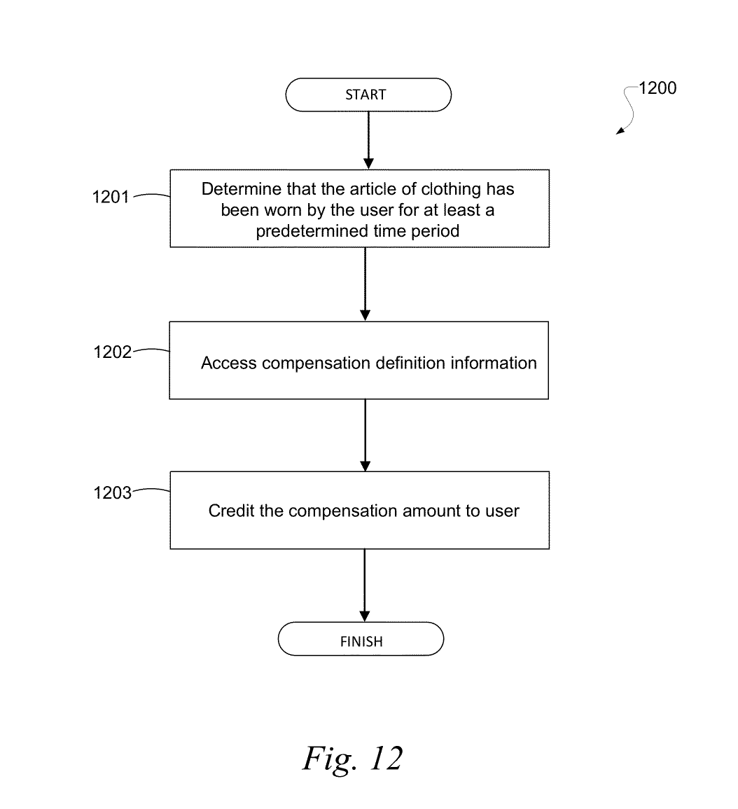

FIG. 12 is a flowchart illustrating an example method 1200, consistent with various embodiments described above. The method 1200 may be performed at least in part by, for example, the smart clothing system 200 illustrated in FIG. 2 (or an apparatus having similar modules, such as one or more client machines or application servers). In operation 1201, the server control module 299a determines, based on the user wear history information, that the article of clothing has been worn by the user for at least a predetermined time period. For example, the server control module 299a may identify, in the user wear history information, all data points during the predetermined time interval indicating that the user is wearing the article of clothing, and the server control module 299a may calculate a total duration associated with these data points. Alternatively, in operation 1201, the server control module 299a determines, based on the user wear history information, that the article of clothing has been worn by the user in an uncovered state for at least a predetermined time period. For example, the server control module 299a may identify, in the user wear history information, all data points during the predetermined time interval indicating that the user is wearing the article of clothing and indicating that the article of clothing is not covered, and the server control module 299a may calculate a total duration associated with these data points. In operation 1202, the server control module 299a accesses compensation definition information defining a fixed compensation amount based on the predetermined time period. In operation 1203, the server control module 299a credits the compensation amount to an online financial account associated with the user. It is contemplated that the operations of method 1200 may incorporate any of the other features disclosed herein. Various operations in the method 1200 may be omitted or rearranged, as necessary.

While various embodiments herein refer to calculating compensation based on how long the user has worn the clothing, the smart clothing system 200 may utilize the inverse operation of calculating how long the user has not worn the article of clothing. For example, the capacitive sensor 202a is configured to detect when the article of clothing is not in physical contact with the user, and to record this information in the user wear history information, consistent with various embodiments described above. The data points in the wear history information indicating that the clothing is not being worn may then be utilized to determine, for example, the total time that the clothing has not been worn, and compensation may be determined accordingly (e.g., a default compensation amount may be reduced based on how long the clothing has not been worn).

In some embodiments, the smart clothing system 200 may determine and take into account where the user has worn the clothing, the movement of the user while wearing the clothing, and how many other people are near the user when they wear the clothing, which may be applied to determine an amount of compensation to be paid to the user. For example, the smart clothing system 200 may compensate the user more for wearing the clothing when they are walking around a crowded place (e.g., when more people are likely to see the user and the article of clothing), as opposed to wearing the clothing while sitting down at home or while driving their car (e.g., when few people are likely to see the user and the article of clothing).

For example, in some embodiments, the smart clothing system 200 receives data points from the sensors, where each of the data points identify whether the article of clothing is being worn, not worn, covered, uncovered, etc., at a given time, as described above. The smart clothing system 200 may assign weights to each of the data points indicating a measure of the inferred strength of the advertising provided or exposure of the advertisement by the user (e.g., the likelihood that others are viewing the article of clothing). For example, in some embodiments, the smart clothing system 200 may weigh the data points based on the location of the user. The smart clothing tag 201 may include a geolocation system (e.g., global positioning system (GPS) or other geolocation system well understood by those skilled in the art), and the geolocation system may associate a location with each of the data points. Alternatively, location co-ordinates from a bridging device (e.g., the GPS of the user's smartphone) may be utilized. If the associated location corresponds to the home of the user, then the weighting applied to those data points may be lower than the weighting applied to other data points that are not associated with the home of the user. Similarly, if the associated location corresponds to an urban location known to be frequented by larger numbers of people (e.g., a busy street or intersection, a sports or entertainment venue, a shopping center, a retail store, a town square in a city, etc.), the weighting applied to these data points may be higher than the weighting applied to other data points that are associated with suburban or rural locations known to be frequented by fewer people. In some embodiments, the smart clothing system 200 may determine the number of users around a particular user. (e.g., by detecting the number of other smart clothing. smart devices, cell phones or smartphones located within a particular distance of the user's smartphone, using any known technique understood by those skilled in the art). Thereafter, the smart clothing system 200 may apply a greater weight to data points obtained when there are larger numbers of other people around the user. The smart clothing system 200 may use two methods in order to predict relative population density or impression potential which would imply greater product exposure. Firstly, the smart clothing system 200 may utilize the on board Bluetooth and Wi-Fi radios built into smart phones to occasionally poll the surroundings for responsive communications from other devices. The smart clothing system 200 does not necessarily need to know what the response data is, but may simply look at the unencrypted device identifier (MAC address) that is sent with every response packet and count how many unique addresses have been received. Similarly, the smart clothing tag 201 may count the amount of Bluetooth devices in range. Secondly, the user's smart phone may store its location data at certain intervals, and when that data is exported to the cloud based data system or web servers 299 along with information from the smart clothing system 200, a map of the user's movements may be generated. This map could then be compared with aggregate cellphone/location data maps that cellular companies generate. These maps are created using all the location services of the devices connected to the network and are used to show population densities in different parts of cities. If a user spent more time in high density locations, then it can be calculated that the clothing received more impressions with a high level of accuracy.

Moreover, in some embodiments, the smart clothing tag 201 may be configured to detect movement of the user, which may influence the weighting applied to data points. For example, the smart clothing system 200 may apply a greater weight to data points if a geolocation system determines that the user is moving around on a busy street versus when the user is stationary on the busy street. Moreover, accelerometers 202d can be used to validate readings from the geolocation sensors by sensing the person's general movements and whether the user is walking or driving. For example, if the geolocation sensors indicate that the person is moving through a crowded street, and the accelerometer indicates that the person is walking, then the weighting applied to these data points may be higher than if the accelerometer indicates that the person is not walking (e.g., the person is driving their car). Certain accelerometers chips also have interrupt lines built into them which would enable the smart clothing system 200 to enter a low-power sleep mode if they are not used which may greatly increase battery life. The accelerometer data can also be used for other purposes such as informing the person how far they walked in a day (similar to the function of a pedometer but conveniently built into their clothing), further incentivizing the user to wear the clothing having the embedded or attached smart clothing tag 201. In some embodiments, multiple articles of clothing may include smart clothing tags 201 that may communicate with one another in order to verify readings (e.g., multiple accelerometers may verify that the user is walking vs. driving). Multiple accelerometers may better confirm data by cross referencing each other, for example, if a user was running both articles with a smarting clothing system could verify, and potentially save energy by pulling only one device out of sleep mode when within range of another smart clothing tag 201 with the same owner. The device being pulled out of sleep mode may be determined by which smart clothing tag 201 has the most reserved energy. The above mentioned capabilities also incentivize users to wear smart clothing systems by allowing them to know where they were. For example, in some embodiments, the smart clothing system 200 can also act as an “Auto-Check-in” feature, providing information of where that user was and for how long. The accelerometer could be used to provide the user with other useful, interesting information (e.g. how many steps the user has taken in a day, how much elevation the user has climbed, calories burned, and other fitness related data, etc.).

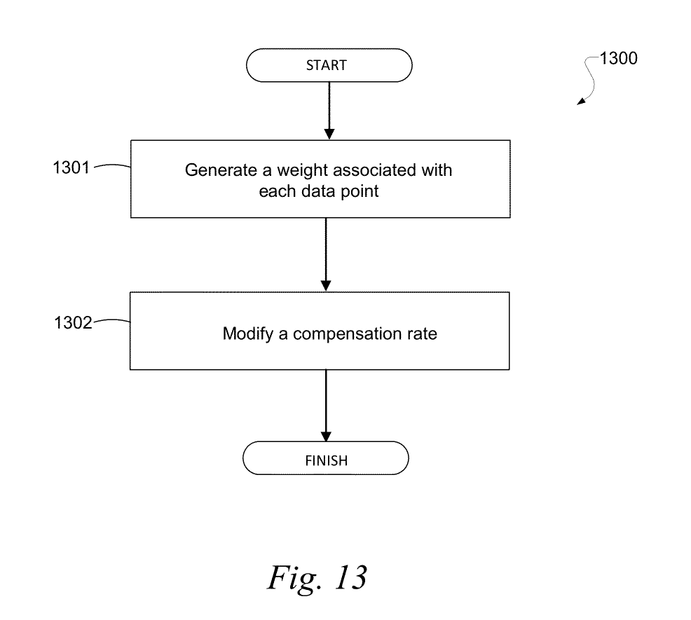

FIG. 13 is a flowchart illustrating an example method 1300, consistent with various embodiments described above. The method 1300 may be performed at least in part by, for example, the smart clothing system 200 illustrated in FIG. 2 (or an apparatus having similar modules, such as one or more client machines or application servers). In operation 1301, the server control module 299a generates a weight associated with each of the data points in the user wear history information, each of the weights indicating a likelihood of impressions of the article of clothing by additional users at the corresponding data point. In operation 1302, the server control module 299a modifies a compensation rate utilized to calculate a compensation amount for a given time interval in the user wear history information that includes a set of one or more data points, based on the weights associated with the set of data points. It is contemplated that the operations of method 1300 may incorporate any of the other features disclosed herein. Various operations in the method 1300 may be omitted or rearranged, as necessary.

In some embodiments, the operation 1301 may comprise generating weights based on the location of the user. More specifically, the server control module 299a may determine, for a given data point in the wearing behavior information, based on geolocation data from the user's smartphone, whether the user is in a populated area, and may generate the weight associated with the given data point accordingly. For example, the server control module 299a may determine, for a given data point, a current location of the user (e.g., based on geolocation information from the user's smart phone). The server control module 299a may then access population information indicating an estimated number of users at various candidate locations. The server control module 299a may then identify an estimated number of users at the current location, based on the population information. The server control module 299a may then generate the weight associated with the given data point, based on the estimated number of additional users at the current location (e.g., the higher the number of additional users, the greater the weight). In some embodiments, the operation 1301 may comprise generating weights based on the estimated number of additional users around the user. For example, the server control module 299a may determine, for a given data point, a number of other devices (e.g., mobile devices, wearable devices, base stations, end points that may include any device that can communicate with the smart clothing tag 201 or user's smartphone, etc.) in close proximity to the user. The server control module 299a may then estimate a number of additional users in close proximity to the user, based on the determined number of other devices. The server control module 299a may then generate the weight associated with the given data point, based on the estimated number of additional users (e.g., the higher the number of additional users, the greater the weight). In some embodiments, the operation 1301 may comprise generating weights based on whether the user is stationary, walking, or driving. For example, the server control module 299a may determine, for a given data point, based on accelerometer data and geolocation data, whether the user is currently stationary, walking, or driving. The server control module 299a may then generate the weight associated with the given data point, based on the determination of whether the user is currently stationary, walking, or driving (e.g., the weight for walking may be greater than the weight of being stationary, and the weight for being stationary may be greater than the weight for driving). In some embodiments, the operation 1301 may comprise generating weights based on whether the user is faced operate or is laying down. For example, the server control module 299a may determine, for a given data point, based on accelerometer data, whether the user is currently laying down (e.g., if the accelerometer 202d indicates that the smart clothing tag 201 has changed orientation). The server control module 299a may then modify (e.g., decrease) the weight associated with the given data point, based on the determination that the user is currently laying down.

According to various example embodiments, the smart clothing system 200 is configured to perform various analytics based on the information that may be stored in various smart clothing tags 201. For example, as described above, each smart clothing tag 201 may include memory 212 configured to store information about the user of the corresponding piece of clothing, memory 210 configured to store information about the product itself, and memory 214 configured to store information about the user's wearing activity/behavior with respect to the article of clothing. While various conventional systems may be configured to keep track of clothing items being sold and to generate and maintain analytic data about the sale of clothing items, such existing systems are not configured to collect or maintain information about the wearing activity/behavior of such clothing items. In contrast, the smart clothing system 200 described herein is configured to collect complex, rich, and deep information about the pre-sale and post-sale activity of various users. Such information can be leveraged to help retailers understand the performance of their inventory, what items on sale are popular, how often an article of clothing received interaction or interest, and so on.

For example, based on the various information that may be stored on the 210, the 212, or the 214 of the smart clothing tag 201 as described in various embodiments above, the smart clothing system 200 may acquire and collect such data from the smart clothing tag 201 that may be used to identify various trends in the wearing behavior of a particular user. For example, such data may indicate that the user wears a particular article of clothing at certain times of the day, or certain days of the week, or certain weeks, months, or seasons of the year, and so on. For instance, the smart clothing system 200 may determine that the user tends to wear a particular article of clothing during work hours on weekdays, whereas the user tends to wear another piece of clothing during the afternoons on weekends, whereas the user tends to wear yet another piece of clothing on Saturday nights during summer, and so on. As another example, the smart system clothing 200 may determine that the user isn't wearing a particular item of clothing at all, and may notify them (e.g., via a mobile application or webpage associated with the smart clothing system 200) to given them the option to consider further options (e.g. selling or giving away that article of clothing). Moreover, by collecting such data from a large number of smart clothing tags 201 associated with clothing items being used by a large number of users in different geographic locations, the smart clothing system 200 may identify trends describing the wearing activity and behavior of a large population of people. For example, by analyzing the wearing behavior information (stored in the 214) in conjunction with various end-user information (stored in the 212) and various product information (stored in the 210) maintained by the smart clothing tags 201, the smart clothing system 200 may identify that users in a particular demographic (e.g., 18-29 year olds in the San Francisco Bay area) tend to where a particular type of clothing (e.g., jeans and T-shirts) during certain times of the day, whereas a different demographic (e.g., 30-40-year-olds living in New York City) tend to wear different clothing during the same time periods. Accordingly, the smart clothing system 200 may collect, maintain, and analyze, rich data from the smart clothing tags 201 that describe the wearing activity and behavior of various users, in order to ultimately identify various trends in the wearing behavior of such users. Such trends may be communicated to clothing manufacturers and retailers, so that they know the post sales utilization and popularity of their products, and so that they can optimize their operations accordingly. Thus, designers and customers can better know what is trending. Moreover, such trends can be utilized to provide recommendations to users, possible resulting in changes in user behavior. For example, instead of checking the weather to know what to wear, users can check online (e.g., via a mobile application or webpage associated with the smart clothing system 200) for what others are wearing and/or recommendations for what to wear. In some embodiments, users can get added rewards or recommendations if they state and/or share (e.g., on Facebook®, Twitter®, Instagram®, Pinterest®, or other social platform) what clothing they are wearing with the smart clothing tag 201, or if they just passively wear clothing with the smart clothing tag 201.

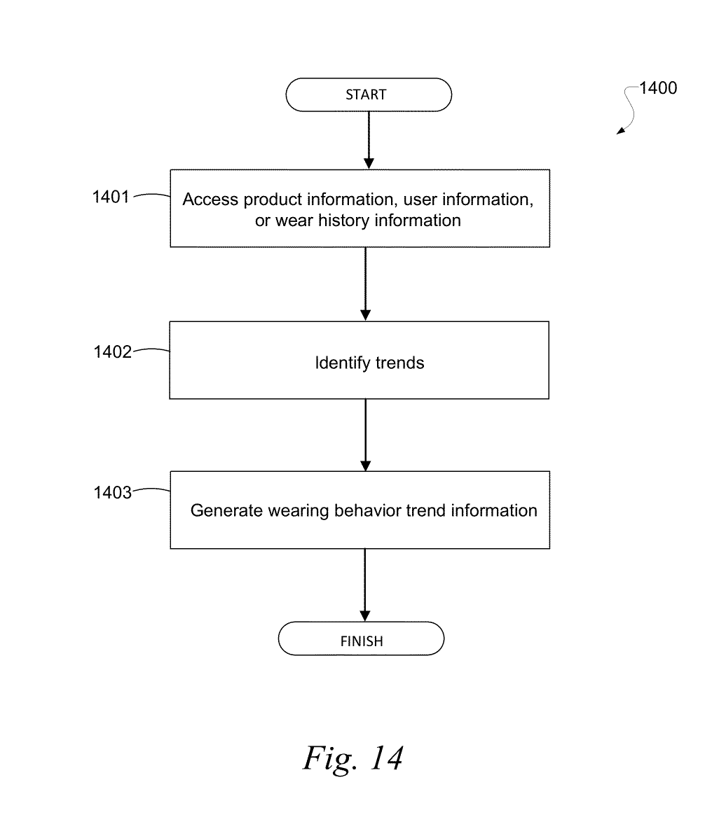

FIG. 14 is a flowchart illustrating an example method 1400, consistent with various embodiments described above. The method 1400 may be performed at least in part by, for example, the smart clothing system 200 illustrated in FIG. 2 (or an apparatus having similar modules, such as one or more client machines or application servers). In operation 1401, the control module 299a accesses product information, user information, or wear history information from one or more smart clothing tags 201 associated with one or more users. For example, such information may be automatically uploaded from the smart clothing tags 201 to the server(s) 299, either directly or via a bridging device (e.g., the user's smartphone). As another example, such information may be scanned from the smart clothing tags 201 by a scanning device (e.g., a camera on the user's smartphone, an NFC, Bluetooth, or RFID scanning device in the user's home or in a retail store), and then uploaded to the server(s) 299. In operation 1402, the control module 299a identifies trends in the various information accessed in operation 1401. For example, the control module 299a may identify, based on the user information, a set of users sharing similar attributes (e.g., location, age, preferences, interests, purchase history, etc.), and then the control module 299a may identify, based on the product information and the wear history information associated with this set of users, trends regarding the items of clothing that the set of users tends to wear (e.g., at different times and/or at different locations). In operation 1403, the control module 299a generates wearing behavior trend information specifying the trends identified in operation 1403. It is contemplated that the operations of method 1400 may incorporate any of the other features disclosed herein. Various operations in the method 1400 may be omitted or rearranged, as necessary.

As described herein, information stored on the smart clothing tags 201 may be read/scanned and acquired from readers/scanners, using any technique known by those skilled in the art. For example, in some embodiments the smart clothing tags 201 may include or corresponded to an RFID tag, and thus an RFID scanner/reader incorporated into a smartphone or scanner in a retail store may be configured to scan information stored on the smart clothing tag 201. In addition to RFID, other well-known examples of technology that may be used to scan information stored on tags include Bluetooth, Bluetooth Low Power (Bluetooth LE), QR codes, Near Field Communication (NFC), Bump, Apple Airdrop, and so on.

According to various example embodiments, the smart clothing system 200 described herein may operate in accordance with a “personal shopper” application that provides recommendations to users on what to wear. This may be a mobile application installed on a smartphone that a consumer may utilize upon entering a retail store, with information that is fueled by the smart clothing tag's 201 collection of data (e.g., their wear history information and their user information including their purchase history), or by information inputted directly by the user. For example, in various embodiments, tag readers or tag scanners configured to scan and acquire information stored on the smart clothing tags 201 described herein may be deployed in specific locations within (or proximate to) retail establishments and other businesses. For example, a tag scanner may be deployed at the entrance/exits of a retail store, such that when a user wearing clothing that includes the smart clothing tag 201 described herein enters the store, the smart clothing tag 201 scanners are configured to scan the various information stored on the smart clothing tags 201 (e.g., end-user information stored in the 212, product information stored in the 210, and wearing behavior information stored in the 214, etc.) and to adjust the shopping experience of the user in that retail store, based on the scanned information. For example, in some embodiments, the smart clothing system 200 may identify what the user is currently wearing (based on the product information stored on the smart clothing tags 201) as well as certain demographic information about the user (based on the end-user information included in the smart clothing tags 201) in order to provide product recommendations for the user. For example, the smart clothing system 200 may generate the aforementioned recommendations by analyzing analytics data (e.g., maintained by the smart clothing system server 299 itself, or by a databases associated with the clothing manufacturer or the clothing retail store), which may indicate trends such that, for example, users from a particular demographic group and/or currently wearing a certain type of clothing tend to purchase specific types of clothing, and so on. In some embodiments, the smart clothing system 200 may also take into account the wearing behavior information stored on the smart clothing tags 201 associated with one or more users when making product recommendations. For example, such information may indicate that previous users that purchased product A and product B only tend to wear product A, and thus the smart clothing system 200 will recommend product A and not product B. Thus, the smart clothing system 200 may utilize the wearing behavior information in conjunction with prior purchase history information in order to generate product recommendations. Product recommendations may also be generated based on trending styles, colors or expert recommendations. Product recommendations may be pushed by the smart clothing system 200 to a smartphone associated with the user (e.g., via e-mail, text message, instant message, etc.), or transmitted to an employee working in the retail store, or displayed on display screens within the retail store, etc. Thus, the smart clothing system 200 may utilize large amounts of data collected from large amounts of smart clothing tags 201 worn by large amounts of users entering the store, in order to provide customized product recommendations for each particular user entering the store.

In some embodiments, the analytic data obtained from the smart clothing tags 201 by the smart clothing tag readers in a retail store may be utilized by a smart clothing system 200 to provide various analytics and recommendations to the retail store itself. More specifically, the data obtained from smart clothing tags 201 from users entering into a clothing store may indicate that, for example, specific demographics of user wearing specific types of clothes and exhibiting specific wearing behavior tend to enter this clothing store and to make specific purchases, which may be used to adjust the retail operations of the store accordingly. For example, the data may indicate that 18 to 24-year-olds tend to purchase and/or wear specific clothing lines or styles, and thus the smart clothing system 200 may generate recommendations that advertising by the retail store towards that demographic may be adjusted to match such tendencies accordingly. This may incentivize retailers to carry clothing with smart clothing tags 201, because they may be able to better plan where to build more stores based on this information. As another example, the analytics data collected and generated by the smart clothing system 200 may indicate that users only wear certain types of clothing during certain seasons, and so the smart clothing system 200 may generate recommendations that advertising seasonal of the retail business may be adjusted accordingly. As another example, the analytics data collected and generated by the smart clothing system 200 may indicate that the users tend to wear a particular article of clothing during working hours on weekdays or on Friday and Saturday nights, and thus the smart clothing system 200 may generate recommendations that advertising associated with these articles of clothing may be adjusted accordingly (e.g., advertisements showing shoes should feature an office or work setting vs. a dance club setting). As another example, the analytics data collected and generated by the smart clothing system 200 may indicate that the users tend to wear a particular article of clothing at a specific location (e.g., the beach), and so the smart clothing system 200 may generate recommendations that the advertising associated with this article of clothing may be adjusted to refer to this specific location accordingly. Thus, the analytic data provided by the smart clothing tags 201 described herein may provide retailers with the opportunity to analyze and understand wearing behavior of their customers, to know what they have to replenish, what their competitors are doing, how to advertise effectively, etc.

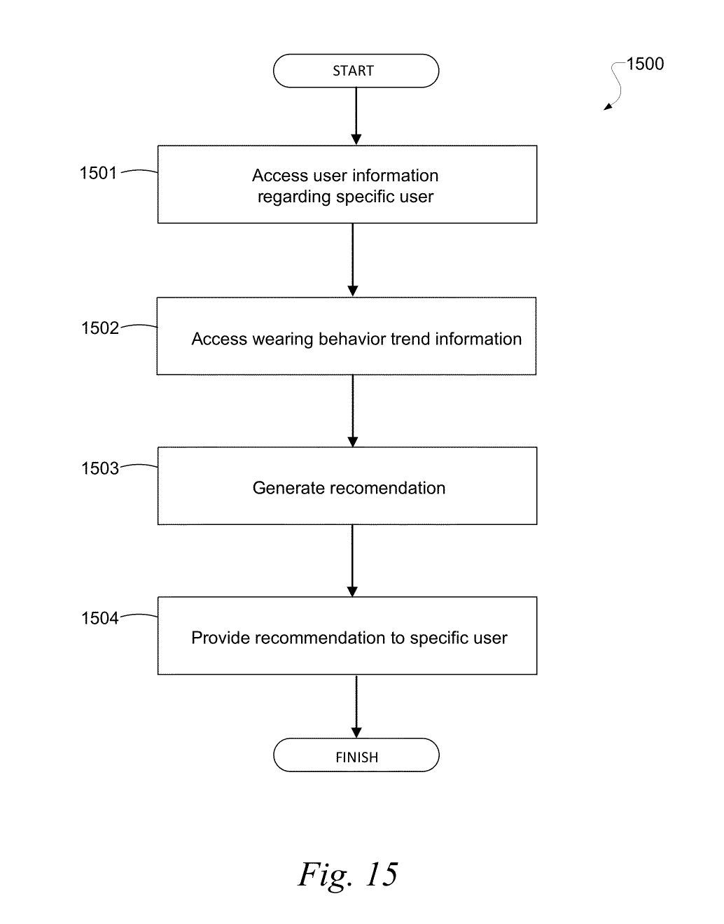

FIG. 15 is a flowchart illustrating an example method 1500, consistent with various embodiments described above. The method 1500 may be performed at least in part by, for example, the smart clothing system 200 illustrated in FIG. 2 (or an apparatus having similar modules, such as one or more client machines or application servers). In operation 1501, the control module 299a accesses user information associated with a specific user. For example, the user may log into an online account associated with a mobile application or webpage associated with the smart clothing system 200, where the online account specifies various attributes about the user (e.g., age, location, preferences, purchase history information, etc.). As another example, such information may be automatically uploaded from the smart clothing tag 201 associated with the specific user to the server(s) 299, either directly or via a bridging device (e.g., the user's smartphone). As another example, such information may be scanned from the smart clothing tag 201 associated with the specific user by a scanning device (e.g., a camera on the user's smartphone, an NFC, Bluetooth, or RFID scanning device in the user's home or in a retail store), and then uploaded to the server(s) 299. In operation 1502, the control module 299a accesses wearing behavior trend information specifying wearing behavior trends. For example, the 299 may access the wearing behavior information generated in operation 1403 in FIG. 14 indicating what various sets of users (e.g., sharing similar attributes such as location, age, preferences, interests, purchase history, etc.) tend to wear (e.g., at different times and/or at different locations). In operation 1503, the control module 299a generates recommendations for the specific user identified in operation 1501, based on the wearing behavior trend information accessed in operation 1502. For example, the control module 299a may identify attributes of the specific user, such as location, age, preferences, interests, purchase history, etc. based on the user information accessed in operation 1501, and the control module 299a may identify a given set of users in the wearing behavior trend information having matching attributes. The 299a may then retrieve the corresponding trends for the given set of users. In operation 1504, the control module 299a then provides the recommendations generated in operation 1503 to the specific user (e.g., via a mobile application or webpage associated with the smart clothing system 200, or via text messages or emails to the user). It is contemplated that the operations of method 1500 may incorporate any of the other features disclosed herein. Various operations in the method 1500 may be omitted or rearranged, as necessary.

According to various example embodiments, the smart clothing system 200 described herein may be configured to operate in accordance with a “smart closet” application. For example, a mobile application or website associated with the smart clothing system 200 may be configured to display information regarding all the items of clothing associated with a user (e.g., all items of clothing that contain end-user information identifying the specific user). The user may have a personal account on the website associated with the smart clothing system 200 that they may access via entering user authentication information (e.g., user name, password, etc.). Thus, the user may log into their personal account on a mobile application or website maintained by the smart clothing system 200, in order to immediately see all the articles of clothing in their digital closet. Thus, even though the user is physically removed from their closet and their articles of clothing (e.g., when the users at work or at a restaurant), the user is able to view all their articles of clothing so they may plan what they would like to wear that night, or on an upcoming trip, and so on. The product information stored on the smart clothing tags 201 of the user's clothing may be utilized by the smart clothing system 200 to acquire additional information describing each of the products (e.g., images from the websites of the manufacturers of the products), where such additional information may be utilized to enhance what is displayed to the user via the mobile application or website associated with the smart clothing system 200. The “smart closet” mobile application or website the smart clothing system 200 may utilize past user behavior to make recommendations (e.g., on what to wear or pack), build trends for the user, and find ways for the user to optimize their experience, in accordance with various embodiments described herein.

While various embodiments throughout describe how end user information, product information, and user wear history information that is stored on the smart clothing tags 201 may be acquired by the smart clothing system 200, it is understood that the user may adjust the privacy/security settings associated with the smart clothing tags 201 of all the clothing they own, in order to prevent such information from being read from the smart clothing tag 201 (e.g., when they enter retail establishments), or to prevent such information from even being stored on the smart clothing tag 201. For example, if the user purchased the article of clothing in the retail store, the retail associate may adjust the settings of the corresponding smart clothing tag 201 based on instructions from the user. On the other hand, if the user buys the article of clothing online from a website of the retailer, the user may submit privacy/security settings via a website or mobile application associated with the smart clothing system 200, and the appropriately programmed smart clothing tags 201 may be embedded into the final products that are shipped to the user.

According to various example embodiments, the smart clothing system 200 may be configured to operate in accordance with a “closet marketplace” application. For example, when a user accesses the mobile application or website maintained by the smart clothing system 200 (as described above) and the user views their items of clothing, the user may be able to indicate that a particular item of clothing is available for sale and that this particular item of clothing may be viewed by other users of the smart clothing system 200. For example, when the user clicks on a particular article of clothing displayed on the mobile application or website, the website may display a list of menu options including an option to mark the clothing item as available for sale and another option to adjust the visibility settings of the item (e.g., where the user may specify that the item is private, viewable by everyone, friends of the user only, friends of friends of the user, a specific list of individuals, etc.). Accordingly, when other users or members of the public access the mobile application or website maintained by the smart clothing system 200, they may search, browse, and view articles of clothing that are owned by other users and that are available for sale. A searching user may click on each article of clothing in order to learn more information about that article of clothing, to contact the owner in order to arrange a sale, and so on. Thus, the smart clothing system 200 described herein provides an online marketplace where owners of clothing can offer such clothing items for sale to others in a quick, convenient, and secure manner.

According to various example embodiments, the smart clothing system 200 described herein may operate in accordance with a “social discovery” or “personal storefront” application. For example, in some embodiments, a tag or reader associated with various end user devices (e.g., cell phones and smart phones) may be used to scan information stored on the smart clothing tags 201. Thus, if a user likes a piece of clothing worn by their friends, this user (the “inquirer”) may immediately learn more information about that article of clothing simply by bringing their smart phone near the article of clothing and scanning the information stored on the corresponding smart clothing tag 201. For example, the product information stored on the smart clothing tag 201 (which may include links to websites describing the article of clothing or links to a retailer page or seller page for buying the article of clothing) may be displayed in a web browser of the smartphone of the inquirer. This gives the inquirer an opportunity to buy directly from the same place the clothing owner procured this particular item of clothing. Further, this gives additional incentive for retailers to carry clothing with smart clothing tags 201, so that a direct link to their website may show up upon an inquirer's device when they scan a smart clothing tag 201 in the retailer's articles of clothing.

According to various example embodiments, the smart clothing system 200 may determine which articles of clothing are generating greater interest among the public, as demonstrated by the fact that inquiring users are scanning these articles of clothing more often to learn more about them. For example, whenever a smart clothing tag 201 is scanned by the smartphone of an inquirer, information describing this scanning event may be stored in a scanning event log in the smart clothing tag 201 (e.g., in one of the databases 210, 212, and 214). For example, the information may simply state that “tag XYZ was scanned at 2:45 PM on Jan. 1, 2013”. Accordingly, the smart clothing tag 201 in each piece of clothing may collect a log of scanning activity associated with that smart clothing tag 201, and such information may be uploaded to the servers 299 of the smart clothing system 200 for the purposes of identifying trends in clothing interest. In some embodiments, when an inquirer scans the smart clothing tag 201, information about that inquirer's identity may be stored on the smart clothing tag 201. Thus, the smart clothing tag 201 may include log entries indicating that “user John Smith scanned tag XYZ at 2:45 PM on Jan. 1, 2013”. Thus, the analytic data generated by the smart clothing system 200 based on these scanning event logs may be used to generate extremely refined information about the articles of clothing generating the most interest. For example, the smart clothing system 200 may determine that a particular article of clothing is generating a great deal of interest from users in a first demographic (e.g., age, location) but not users in a second demographic. This information may be leveraged by the smart clothing system 200 for targeted advertising. For example, when an inquirer scans a piece of smart clothing, this information can later be used by the smart clothing system 200 to advertise to that inquirer even if the inquirer didn't immediately act on purchasing the scanned article. This enables retailers to optimize advertising and follow interested users while staying top of mind.

According to various example embodiments, when an inquirer scans an article of clothing in order to learn more information about that article of clothing, various financial incentives (e.g., discounts, coupons, promotions, etc.) may be provided to both the inquirer and the owner of the article of clothing being tagged. For example, the smart clothing system 200 may analyze the scan history logs stored on each smart clothing tag 201 in order to identify how many times that tag has been scanned. The smart clothing system 200 may then provide appropriate compensation to the owner of that article clothing (e.g., the smart clothing system 200 may e-mail coupons, discounts, promotions, etc., to an e-mail address associated with the user that may be stored in the end-user information on the smart clothing tag 201).

In some embodiments, a phone readable QR code and/or NFC sticker may be embedded onto the smart clothing tag 201 for the clothing allowing others to tag or like that specific piece of clothing. Each of these QR and NFC tags may also be specifically coded and tied to the user account to allow the smart clothing system 200 to further reward clothing owners who have actively spread the brand further. This can also give whoever wants to buy the clothing a coupon code associated with a customized hyperlink, URI, or URL, where using that hyperlink to access a site gives money to both the clothing owner that directed people to that domain as well as a discount to anyone using that hyperlink to buy clothing.

In some embodiments, the smart clothing tag 201 may have a “locking/unlocking” feature to “lock” or protect the smart clothing tag 201 before purchase, and to “unlock” it at the time of transfer of ownership to a new owner (providing a compromise between security and ease of transfer of ownership). For example, a seller can transfer and designate the device as purchased and “activate” the device. This activation activity could in a similar manner to cell phone purchases today. The locking mechanism may use a public key encryption or an NFC or proximity based triggered device, or sim card pair protection mechanism. This would allow the smart clothing tag 201 to have “reverse security” capabilities. Instead of detecting theft based on security scanners and magnetic detection, Bluetooth security scanners may be put in place that may detect theft through signal strength, as well as NFC based security. Furthermore with multiple Bluetooth security nodes placed at known distances, the smart clothing system 200 may determine not only if an article of clothing is being stolen, but determine the general direction that the thief went, which may help in identifying them. This security feature can also allow the owner to find lost articles of clothing easily.

### Example Mobile Device

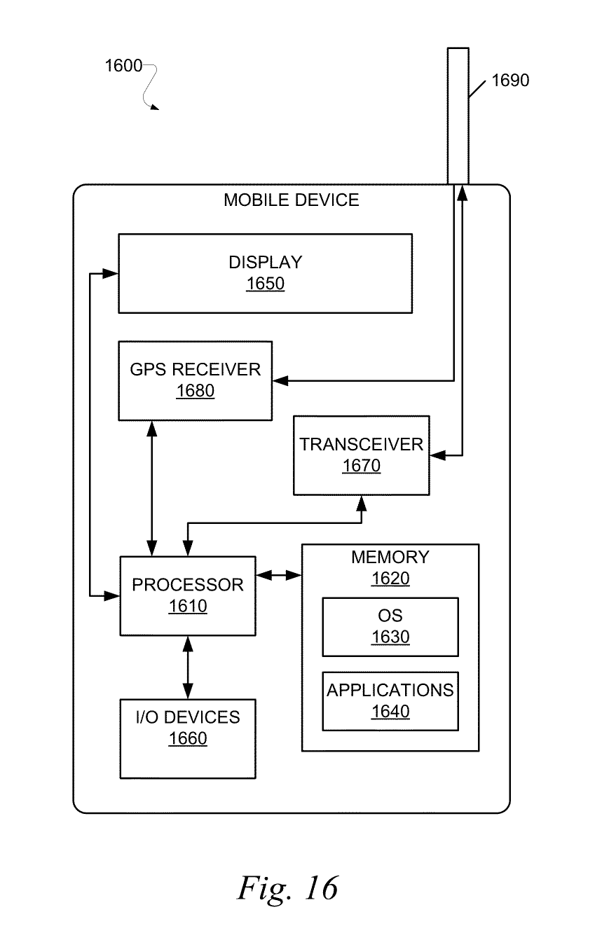

FIG. 16 is a block diagram illustrating the mobile device 1600, according to an example embodiment. The mobile device may correspond to, for example, one or more client machines or application servers. One or more of the modules of the system 200 illustrated in FIG. 2 may be implemented on or executed by the mobile device 1600. The mobile device 1600 may include a processor 1610. The processor 1610 may be any of a variety of different types of commercially available processors suitable for mobile devices (for example, an XScale architecture microprocessor, a Microprocessor without Interlocked Pipeline Stages (MIPS) architecture processor, or another type of processor). A memory 1620, such as a Random Access Memory (RAM), a Flash memory, or other type of memory, is typically accessible to the processor 1610. The memory 1620 may be adapted to store an operating system (OS) 1630, as well as application programs 1640, such as a mobile location enabled application that may provide location based services to a user. The processor 1610 may be coupled, either directly or via appropriate intermediary hardware, to a display 1650 and to one or more input/output (I/O) devices 1660, such as a keypad, a touch panel sensor, a microphone, and the like. Similarly, in some embodiments, the processor 1610 may be coupled to a transceiver 1670 that interfaces with an antenna 1690. The transceiver 1670 may be configured to both transmit and receive cellular network signals, wireless data signals, or other types of signals via the antenna 1690, depending on the nature of the mobile device 1600. Further, in some configurations, a GPS receiver 1680 may also make use of the antenna 1690 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

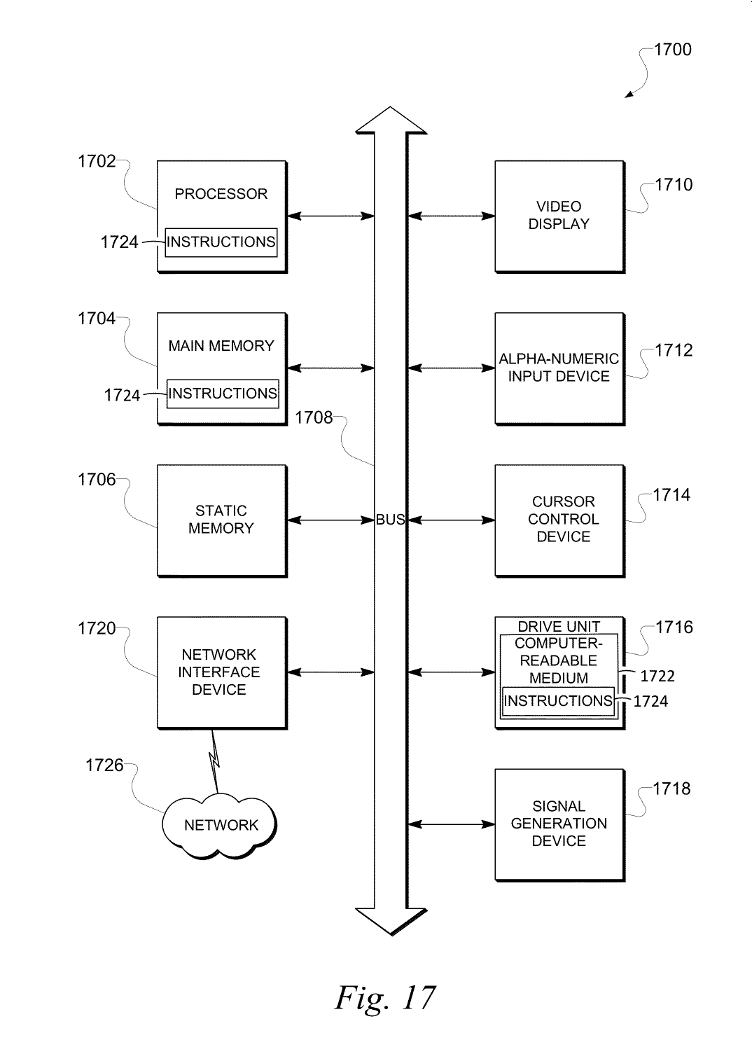

FIG. 17 is a block diagram of machine in the example form of a computer system 1700 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1700 includes a processor 1702 (e.g., a central processing unit (CPU), a graphics processing unit (GPU) or both), a main memory 1704 and a static memory 1706, which communicate with each other via a bus 1708. The computer system 1700 may further include a video display unit 1710 (e.g., a liquid crystal display (LCD) or a cathode ray tube (CRT)). The computer system 1700 also includes an alphanumeric input device 1712 (e.g., a keyboard or a touch-sensitive display screen), a user interface (UI) navigation device 1714 (e.g., a mouse), a disk drive unit 1716, a signal generation device 1718 (e.g., a speaker) and a network interface device 1720.

### Machine-Readable Medium

The disk drive unit 1716 includes a machine-readable medium 1722 on which is stored one or more sets of instructions and data structures (e.g., software) 1724 embodying or utilized by any one or more of the methodologies or functions described herein. The instructions 1724 may also reside, completely or at least partially, within the main memory 1704 and/or within the processor 1702 during execution thereof by the computer system 1700, the main memory 1704 and the processor 1702 also constituting machine-readable media.

While the machine-readable medium 1722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1724 may further be transmitted or received over a communications network 1726 using a transmission medium. The instructions 1724 may be transmitted using the network interface device 1720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
detecting, at a particular time, via one or more sensors embedded in or attached to an article of clothing, that the clothing is in physical contact with a user;
determining that the article of clothing is being worn by the user at the particular time, based on the detecting at the particular time; and
generating, using one or more processors, user wear history information that indicates that, at the particular time, the user is wearing the article of clothing.

2. The method of claim 1, wherein the one or more sensors includes a capacitive sensor configured to detect that the clothing is in physical contact with the user.

3. The method of claim 1, further comprising:
detecting, at a second time, via the one or more sensors embedded in or attached to the article of clothing, that the clothing is not in physical contact with the user;
determining that the article of clothing is not being worn by the user at the second time, based on the detecting at the second time; and
modifying the user wear history information to indicate that, at the second time, the user is not wearing the article of clothing.

4. The method of claim 1, wherein the user wear history information includes one or more data points associated with one or more specified times, each of the data points indicating whether the article of clothing is being worn by the user or is not being worn by the user at the corresponding specified time.

5. The method of claim 1, further comprising:
detecting, at a third time, via the one or more sensors embedded in or attached to the article of clothing, that an amount of reflected light or ambient light reaching the article of clothing is greater than a predetermined threshold;
determining that the article of clothing is not covered at the third time, based on the detecting at the third time; and
modifying the user wear history information to indicate that, at the third time, the article of clothing is not covered.

6. The method of claim 5, wherein the one or more sensors includes an infrared (IR) reflectance sensor or an ambient light detection sensor configured to detect the amount of reflected light or ambient light reaching the article of clothing.

7. The method of claim 5, wherein the determining at the third time further comprises:
emitting, by an infrared (IR) reflectance sensor, an IR light;
detecting, by the IR reflectance sensor, the amount of reflected light emanating from the IR light; and
comparing the amount of reflected light to the predetermined threshold.

8. The method of claim 5, wherein the user wear history information includes one or more data points associated with one or more specified times, each of the data points indicating whether the article of clothing is covered or not covered at the corresponding specified time.

9. The method of claim 1, further comprising:
detecting, at a fourth time, via the one or more sensors embedded in or attached to the article of clothing, that an amount of reflected light or ambient light reaching the article of clothing falls below a predetermined threshold;
determining that the article of clothing is covered at the fourth time, based on the detecting at the fourth time; and
modifying the user wear history information to indicate that, at the fourth time, the article of clothing is covered.

10. The method of claim 1, further comprising determining, based on the user wear history information, the total amount of time that the article of clothing has been worn by the user by:
identifying, based on the user wear history information, data points indicating that the user is wearing the article of clothing; and
calculating a total duration associated with the data points.

11. The method of claim 10, further comprising:
responsive to determining the total amount of time that the article of clothing has been worn by the user, accessing compensation definition information defining a rate of compensation based on a total wearing time; and
calculating a compensation amount, based on the rate and the determined total amount of time that the article of clothing has been worn by the user.

12. The method of claim 11, further comprising crediting the compensation amount to an online financial account associated with the user.

13. The method of claim 1, further comprising:
determining, based on the user wear history information, a total amount of time that the article of clothing has been worn by the user during a predetermined time interval, the predetermined time interval corresponding to a particular day of week, a particular time of day, or a particular season of year;
accessing compensation definition information defining a rate of compensation based on a total wearing time during the predetermined time interval; and
calculating a compensation amount, based on the rate and the determined total amount of time that the article of clothing has been worn by the user during the predetermined time interval.

14. The method of claim 1, further comprising:
generating a weight associated with each of the data points in the user wear history information, each of the weights indicating a likelihood of impressions of the article of clothing by additional users at the corresponding data point; and
modifying a compensation rate utilized to calculate a compensation amount for a given time interval in the user wear history information that includes a set of one or more data points, based on the weights associated with the set of data points.

15. The method of claim 14, wherein the generating further comprises:
determining, for a given data point, a current location of the user;
accessing population information indicating an estimated number of users at various candidate locations;
identifying an estimated number of users at the current location, based on the population information; and
generating the weight associated with the given data point, based on the estimated number of additional users at the current location.

16. The method of claim 14, wherein the generating further comprises:
determining, for a given data point, a number of other devices in close proximity to the user, the other devices including mobile devices, wearable devices, base stations, and end points;
estimating a number of additional users in close proximity to the user, based on the determined number of other devices; and
generating the weight associated with the given data point, based on the estimated number of additional users.

17. The method of claim 14, wherein the generating further comprises:
determining, for a given data point, based on accelerometer data and geolocation data, whether the user is currently stationary, walking, or driving; and
generating the weight associated with the given data point, based on the determination of whether the user is currently stationary, walking, or driving.

18. The method of claim 14, wherein the generating further comprises:
determining, for a given data point, based on accelerometer data, whether the user is currently laying down; and
modifying the weight associated with the given data point, based on the determination that the user is currently laying down.

19. A system comprising:
one or more sensors embedded in or attached to an article of clothing configured to detect that the clothing is in physical contact with a user; and
a control module, comprising one or more processors, configured to:
determine that the article of clothing is being worn by the user at the particular time, based on the detecting at the particular time; and
generate user wear history information that indicates that, at the particular time, the user is wearing the article of clothing.

20. A non-transitory machine-readable storage medium comprising instructions that, when executed by one or more processors of a machine, cause the machine to perform operations comprising:
detecting, at a particular time, via one or more sensors embedded in or attached to an article of clothing, that the clothing is in physical contact with a user;
determining that the article of clothing is being worn by the user at the particular time, based on the detecting at the particular time; and
generating, using one or more processors, user wear history information that indicates that, at the particular time, the user is wearing the article of clothing.
